(19) United States
(12) Patent Application Publication
(10) Pub. No.: US 2025/0191305 A1
(43) Pub. Date: Jun. 12, 2025

(54) EXTENDED-REALITY STOREFRONT BUILDER

(71) Applicants: Jovante Lenard Ham, Houston, TX (US); Darsha Remecia Carter, Houston, TX (US)

(72) Inventors: Jovante Lenard Ham, Houston, TX (US); Darsha Remecia Carter, Houston, TX (US)

(21) Appl. No.: 18/531,968

(22) Filed: Dec. 7, 2023

(51) Int. Cl. G06T 19/00; G06F 3/01; G06F 3/04815; G06F 3/0486; G06Q 30/0601

(52) U.S. Cl. CPC G06T 19/006; G06F 3/013; G06F 3/04815; G06F 3/0486; G06Q 30/0643; G06T 2200/24; G06T 2210/04

(57) ABSTRACT

A system for generating an extended-reality environment may include a head-mounted display configured to be worn by a user, a non-transitory computer memory, and a processor configured to execute computer-readable instructions. The processor may be configured to generate a floorplan of the extended-reality environment. The processor may also be configured to customize the extended-reality environment based on user input. The processor may also be configured to receive input from a user indicating a selection of a product within the extended-reality environment, whereupon the processor may be configured to generate one or more display options in the extended-reality environment.

### TECHNICAL FIELD

The present disclosure is generally related to methods and systems for providing an automated or semi-automated extended-reality (e.g., virtual reality, augmented reality, or mixed reality) storefront builder. The present disclosure also generally relates to methods and systems for allowing user to view and interact with objects within a virtual store.

### BACKGROUND

Extended-reality allows a user to experience a digital world in different ways, including virtual reality, augmented reality, and mixed reality. Virtual reality is a simulated experience which gives a user an immersive feel of a virtual world. Augmented reality combines the real world with one or more overlaid virtual components. Mixed reality merges the real world and a virtual world, such that physical and virtual objects coexist. Typically, a user wears a head-mounted display that allows the user to view the virtual components of the world. Controllers or other input devices may allow the user to interact with virtual objects within the virtual, augmented, or mixed world, as well as move around the world. In some cases, headphones may be used to allow virtual sounds to be heard by the user. Other feedback devices may also be implemented to provide a user feedback in additional senses (e.g., touch, smell, etc.).

### BRIEF DESCRIPTION OF THE DRAWINGS

Detailed descriptions of implementations of the present technology will be described and explained through the use of the accompanying drawings.

FIG. 1 illustrates an extended-reality (XR) system, in accordance with one or more embodiments.

FIG. 2 illustrates an XR head-mounted display (HMD), in accordance with one or more embodiments.

FIG. 3 is a block diagram illustrating a portion of an example blockchain system.

FIG. 4A is a drawing illustrating an application of a hash function, in accordance with one or more embodiments of this disclosure.

FIG. 4B is a block diagram illustrating an example cryptographic wallet, in accordance with one or more embodiments of this disclosure.

FIG. 5 is a block diagram illustrating an example machine learning (ML) system.

FIG. 6 is a block diagram illustrating an example computer system.

FIG. 7 is a flow diagram of a process for generating an extended-reality environment, consistent with various embodiments.

FIG. 8 depicts an example of an extended-reality environment including a plurality of products according to some embodiments

FIG. 9 depicts an example of an interface during a process of building an extended-reality environment according to some embodiments.

FIG. 10 depicts an example of an interface during a process of building an extended-reality environment according to some embodiments.

FIGS. 11A-11C depict examples of an extended-reality environment and virtual activities.

FIG. 12 depicts an example of an extended-reality environment and display options.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The shopping experience in the digital era has largely displaced traditional retail shopping. Many consumers buy goods solely online, oftentimes through third party retailers. As a result, many companies have failed to maintain strong brand association with consumers, and as a result their products do not sell as well in digital shopping as in retail stores. The cause of this lack of brand asso11ciation is that many of the in-store senses are not present in a digital shopping environment. For example, store atmosphere and design, sounds, and even smells are not present in many online storefronts. Rather, many storefronts are simple two-dimensional images of products for sale and related information. These storefronts oftentimes fail to appropriately convey brand messaging to potential customers, and do not provide interactive, sensory experiences.

In some industries, like video gaming, virtual three-dimensional sensory environments have become more common through the introduction of head-mounted displays and other systems that allow a user's senses to engage with virtual environments. These virtual environments can provide a variety of experiences for a user, including emulating activities done in the real world. In some cases, virtual three-dimensional environments for a part of a larger metaverse. Typically, three-dimensional environments developed for extended-reality are custom designed and developed. While this technique provides unique three-dimensional environments and assets, it is also time consuming, difficult, and expensive. Accordingly, many other industries such as fashion and other retailers that would be otherwise interested in creating their own three-dimensional environment are inhibited from doing so. Accordingly, rather the implement three-dimensional environments and other sensory experiences, many retailers retain traditional two-dimensional storefronts that do not fully engage customers.

In view of the forgoing, introduced here are methods, apparatuses, and systems for generating three-dimensional environments and assets for an extended-reality storefront via a no-code application. According to methods described herein, a retailer may generate a three-dimensional environment based on drag-and-drop templates and/or via a generative machine learning model. Additionally, a retailer may generate three-dimensional assets based on input of two-dimensional images. In some embodiments, a traditional two-dimensional storefront may be provided as input to an application that outputs a three-dimensional storefront that may be viewed in extended-reality. In this manner, user may shop digitally in three dimensions. In some cases, a three-dimensional environment may also provide for interactivity (e.g., games, manipulation of objects, etc.) and engagement of other senses (e.g., sound, scent) to engage with potential customers in a manner similar to a retail storefront.

In some embodiments, a computer-implemented method for generating a no-code, three-dimensional extended-reality environment includes generating a floorplan of the extended-reality environment based on a pre-defined floorplan representative of an interior of a virtual three-dimensional store. In some embodiments, the floorplan may be generated based on input received from a user, for example, a selection between a plurality of pre-defined floorplans. In some embodiments, the floorplan may be generated according to one or more parameters selected by a user, for example, size, color, theme, etc. The method may also include generating an avatar that is displayed within the extended-reality environment. The avatar may be a representation of the user within the three-dimensional space. The method may also include customizing the extended-reality environment by generating at least one selected from the group of: a virtual interactive activity, a virtual customizable asset, a picture of a product, wall art, and background music. Examples of such customizations are discussed in detail further below. The method may include receiving an indication of a selection of a product from a user, and presenting one or more display options associated with the selected product. In some embodiments, the display options may include at least one selected from the group of: a manipulable three-dimensional model of the selected product, additional information related to the selected product, the product being used by the avatar in the virtual three-dimensional store to enable visualization of the selected product, the product in the virtual simulation of a physical environment to enable visualization of the selected product, and a payment platform wherein the user is able to purchase the selected product without leaving the extended-reality environment. Examples of such display options are discussed in detail further below.

According to exemplary embodiments herein, methods and system may allow a user to customize an extended-reality environment. The customizations may include at least one selected from the group of: a virtual interactive activity, a virtual customizable asset, a picture of a product, wall art, and background music. In some embodiments, the customizations may correspond to objects stored in memory that may be rendered into the extended-reality environment. In some embodiments, a method may include providing a graphical user interface (GUI) on a display to a user. The method may include presenting options for customization to a user. By selecting between lists of options and/or importing pre-existing digital assets, a user may construct an extended-reality environment may be constructed by a user without the use of code.

In some embodiments, a user may be able to select between a plurality of virtual activities to incorporate into an extended-reality environment. Virtual activities may include, but are not limited to, games, sports simulations, puzzles, three-dimensional object manipulation, etc. A virtual interactive activity may be one in which a system is configured to receive input from a user (e.g., from one or more input devices) to change objects in the extended-reality environment.

In some embodiments, a user may be able to select between a plurality of pictures of a product. In some embodiments, a user may be able to import an image of a product into the system to select and add to the extended-reality environment. Examples of importing an asset are discussed further below. In some embodiments, a selected picture may be rendered on a wall of the extended-reality environment. In other embodiments, a selected picture may be used as an input to a generative machine learning model that generates a three-dimensional object from a two-dimensional image file. An example of generating a three-dimensional model for an extended-reality environment based on a two-dimensional asset file is discussed further below. In some such embodiments, the three-dimensional object may be rendered in the extended-reality environment. In some embodiments, a user may be able to select between a plurality of two-dimensional images that may be rendered as wall art in an extended-reality environment. In some embodiments, the two-dimensional images may be rendered inside of three-dimensional frames within the extended-reality environment. In some embodiment, a user may select between a plurality of two-dimensional images that may be rendered in the extended-reality environment (e.g., on a wall, virtual display such as a television, etc.). In some embodiments, rendering a two-dimensional asset in a three-dimensional extended-reality environment may include generating rendering a rectangular prism with a minimal or zero thickness for the asset in three-dimensional space by assigning an orientation of the rectangular prism. In some embodiments, two-dimensional images or video content may be rendered in a three-dimensional environment.

In some embodiments, a user may be able to select between a plurality of music tracks or other audio for rendering into an extended-reality environment. In some embodiments, a selected music track may be rendered in an extended-reality environment as sound. The sound may be delivered to a user of a head-mounted display via headphones and/or speakers. In some embodiments, a user may also be able to select ambient soundtracks. Ambient soundtracks may correspond to ambient sounds heard in different environments (e.g., city/urban, neighborhood, stream, ocean, etc.). In some embodiments, ambient sounds may be rendered into an extended-reality environment in addition to or in instead of a music track. In this manner, a user can construct an extended-reality environment with a desired audio experience. In some embodiments, music soundtracks or ambient soundtracks may be sound files in any audio file format, for example, WAV, FLAC, and MPEG (e.g., MP3).

In some embodiments, a system may be configured to receive input from a user that indicates a selection of a product in an extended-reality environment. In some embodiments, the user input may be received via one or more controllers, for example, handheld controllers. In other embodiments, the user input may be received via a sensor of a head-mounted display. For example, a head-mounted display may include an eye tracking sensor configured to track the eyes of a user, and a product selection may be indicated by looking at an object for a non-zero period of time. In this example, an indication of a selected product may be made by an ocular movement detected by a head-mounted display. As another example, a head-mounted display may include an accelerometer configured to detect motion of a user's head, and a gesture based on a motion of the user's head (e.g., a nod) may be received as an input indicating a selection of a product.

Upon reception of user input indicating a selection of a product, a system may be configured to generate and render into an extended-reality environment one or more display options associated with the selected product. In some embodiments, the display options may include at least one selected from the group of: a manipulable three-dimensional model of the selected product, additional information related to the selected product, the product being used by the avatar in the virtual three-dimensional store to enable visualization of the selected product, the product in the virtual simulation of a physical environment to enable visualization of the selected product, and a payment platform wherein the user is able to purchase the selected product without leaving the extended-reality environment.

In some embodiments, a manipulable three-dimensional model of the selected product may be displayed to a user and a user may be able to move the three-dimensional model in the extended-reality environment with user input. In some embodiments, such a model may be generated by a generative machine learning model based on input one on or more two-dimensional digital assets.

In some embodiments, additional information related to the selected product may be rendered as text in the extended-reality environment. The additional information may be product specifications, in some cases. In some embodiments, the product being used on the avatar may be based on a classification of the product input by a user while configuring the extended-reality environment. For example, clothing may be shown worn by an avatar according to a type of clothing. As another example, a handheld object may be rendered in a hand of the avatar.

In some embodiments, the product may be displayed in another physical environment different than the extended-reality store environment. For example, a tent may be rendered in a campsite, or sports equipment may be rendered on a sports field or court. In some embodiments, a payment platform may be rendered in the extended-reality environment (e.g., as text) allowing a user to complete a purchase within the extended-reality environment.

In some embodiments, a payment platform may be connected to an online sales platform. The online sales platform may be configured to record a quantity of product available for purchase and provide that information to the payment platform. For example, the online sales platform may transmit a quantity of the product available for purchase. The online sales platform may further update the quantity upon receipt of a sale from the payment platform. For example, the online sales platform may receive a purchase request from the user, and update the quantity upon receive of the purchase request.

Each of the above-described display options may be configured by a user based on selection between a plurality of options and input of information during configuration of the extended-reality environment. Accordingly, these display options may be incorporated into an extended-reality environment without use of code for an end user. In some embodiments, display options may be rendered in an extended-reality environment without obscuring other display options that were previously rendered.

According to exemplary embodiments herein, an extended-reality environment may include two-dimensional or three-dimensional objects that are based on imported assets provided by a user. In many conventional websites, products are depicted in two-dimensional images. Accordingly, many users possess two-dimensional image files that may be employed to generate assets for display in a three-dimensional extended-reality environment. In some embodiments, system here may employ a generative machine learning model configured to output a three-dimensional model based on one or more two-dimensional image file inputs. A generative machine learning tool may include a generative machine learning algorithm. The generative machine learning algorithm may be trained to generate, in response to input training data, a corresponding three-dimensional model of a product based on two-dimensional images and/or other input (such as a category of product). The three-dimensional model of a product that is generated by the generative machine learning tool may include newly generated portion of content that shares one or more properties with the input training data and thereby extends the input training data.

By providing a plurality of pre-defined floorplans, allowing a user to select between a plurality of configuration options, and allowing for the importation of asset files, a computer-implemented method according to embodiments herein can:
Build a customized storefront according to a permutation of selected options of pre-defined assets using no code;
Generate an extended-reality environment with a graphical user interface;
Provide an interactive shopping experience including optional interactive elements;
Display customized or imported two-dimensional assets in the extended-reality environment;
Generate custom three-dimensional assets in the extended-reality environment from two-dimensional digital assets; and
Allow consumers to buy products in an extended-reality environment without leaving the extended-reality environment.

In some embodiments, a head-mounted display may be located in a physical store. In some such embodiments, the extended-reality environment may be customized to augment a shopping experience in a physical store. In other embodiments, a head-mounted display may be located in a location other than a physical store, such as a user's home.

Embodiments of the present disclosure are described thoroughly herein with reference to the accompanying drawings. Like numerals represent like elements throughout the several figures, and in which example embodiments are shown. However, embodiments of the claims can be embodied in many different forms and should not be construed as limited to the embodiments set forth herein. The examples set forth herein are non-limiting examples and are merely examples, among other possible examples.

Throughout this specification, plural instances (e.g., “400”) can implement components, operations, or structures (e.g., “400a”) described as a single instance. Further, plural instances (e.g., “400”) refer collectively to a set of components, operations, or structures (e.g., “400a”) described as a single instance. The description of a single component (e.g., “400a”) applies equally to a like-numbered component (e.g., “400b”) unless indicated otherwise. These and other aspects, features, and implementations can be expressed as methods, apparatuses, systems, components, program products, means or steps for performing a function, and in other ways. These and other aspects, features, and implementations will become apparent from the following descriptions, including the claims.

The advantages of the convolutional neural network (CNN) used for machine learning (ML) in the disclosed embodiments include the obviation of feature extraction and the use of shared weight in convolutional layers, which means that the same filter (weights bank) is used for each node in the layer; this both reduces memory footprint and improves performance.

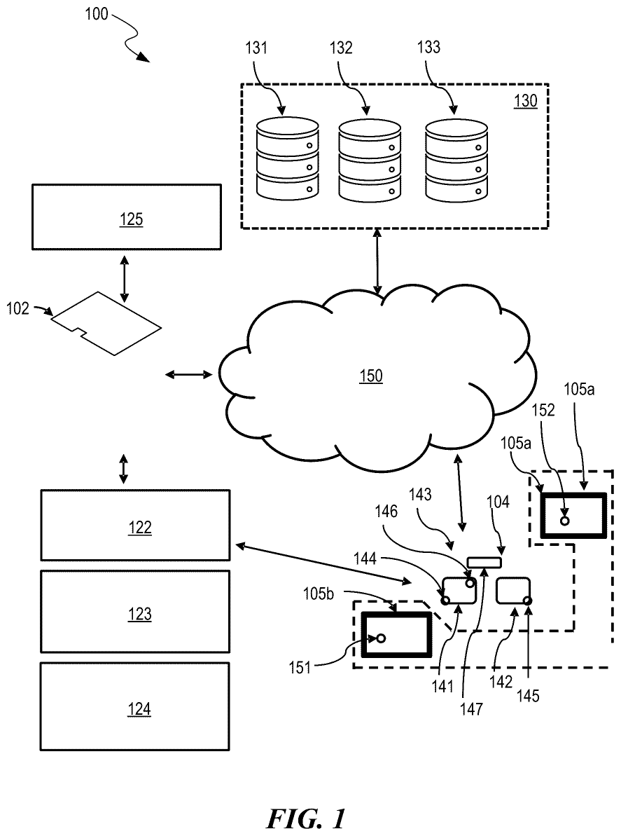

FIG. 1 illustrates an extended-reality (XR) system 100, in accordance with one or more embodiments. Extended-reality is a catch-all term to refer to augmented reality, virtual reality, and mixed reality. The technology is intended to combine or mirror the physical world with a “digital twin world” that is able to interact with each other. System 100 can be used to perform an XR computer-implemented method. For example, system 100 can be used in conjunction with determining network parameters associated with a network communicably coupling a base station to a video streaming server, receiving a video stream from the video streaming server, etc.

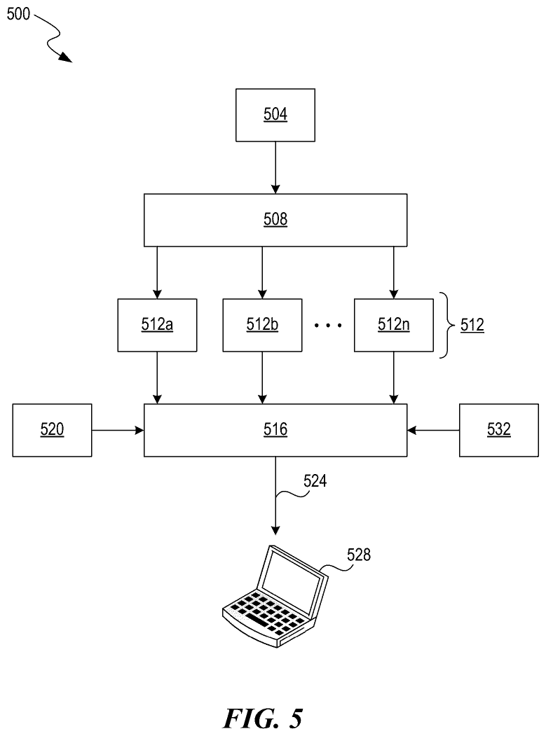

System 100 can be used to extract a feature vector from network parameters associated with a network (e.g., network 150) communicably coupling the base station to an XR device (e.g., wearable device 104) executing an XR application, transcode a video stream based on the feature vector, send the transcoded video stream to the XR device for combining the video stream with a second video stream into an XR video stream for display on an electronic display of the XR device by the XR application, or train machine learning (ML) systems. An example ML system 500 is illustrated and described in more detail with reference to FIG. 5.

System 100 can analyze system performance and then generate additional simulations based on the system performance to simulate the processes described herein any number of times. System 100 can remove, add, or modify actions based on, for example, system performance, user input, predicted events, outcomes, or the like. System 100 can generate an XR environment (e.g., an augmented reality (AR) environment or other environment) with displayed event information (e.g., mappings of moving objects), instrument data (e.g., instrument instructions, operational parameters, etc.), sensor data, user data (e.g., real-time behavior), and other information for assisting the user.

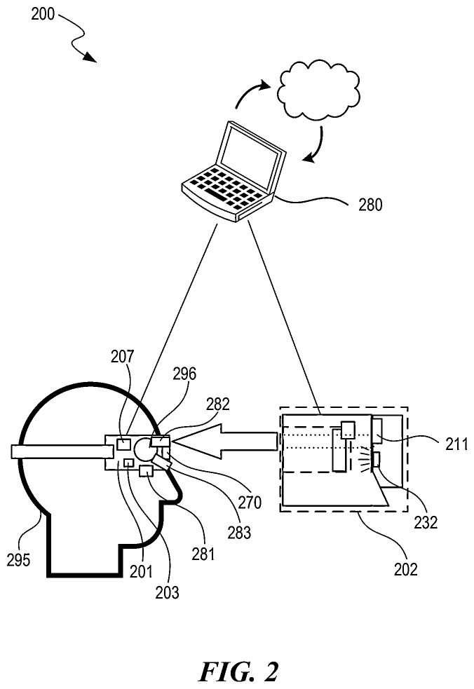

System 100 can include an AR device (e.g., wearable device 104) that provides virtual reality (VR) simulations for monitoring of behavior, activities, or other changing information. VR is a simulated experience that employs pose tracking and 3D near-eye displays to give the user an immersive feel of a virtual world. In some embodiments, system 100 generates an XR simulation environment that includes a digital environment model. The digital model is viewable by at least one user using an AR device, such as the devices illustrated and described in more detail with reference to FIGS. 1-2. The XR simulation environment is configured to enable the at least one user to virtually perform one or more steps on the digital model. For example, the user can identify behavior, activities, or other changing information when viewing a digital twin or a virtual model of the environment.

In some embodiments, system 100 receives feature mapping information from the at least one user via the XR device (e.g., VR device, AR device, etc.). In some embodiments, the same XR device is used to perform VR simulations to input mapping information and perform AR-assisted monitoring on the environment based on the mapping information. In other embodiments, different XR devices are used for training and performing the monitoring of behavior, activities, or other changing information. In some training procedures, multiple users input mapping information, which is aggregated to determine what information is correct. The aggregation can be used to determine confidence scoring for XR mapping. For example, a confidence score for AR mapping is based on a threshold percentage (e.g., at least 80%, 90%, 95%, or 99%) of the users providing the same mapping (e.g., mapping input using an XR environment).

In response to the confidence score reaching a threshold level for features associated with an environment, the mapping can be deployed for performing monitoring of behavior, activities, or other changing information. In AR/VR-assisted monitoring, wearable device 104 can display information to assist the user. The displayed information can include environmental information (e.g., instrument information, movement in a vicinity, or potential adverse events), and other information to assist the user. The user can move, add, or eliminate displayed information to enhance the experience. The configuration of the wearable device 104, information displayed, and feedback provided to the user can be selected based on procedures to be performed.

In some embodiments, system 100 performs confidence-score AR mapping to meet a confidence threshold for an environment. The confidence-score AR mapping includes selecting at least a portion of the mapping information for the AR mapping to the environment. The selected mapping information is mapped to the environmental features. Via the AR device, an AR environment is displayed to the at least one user. The AR environment includes the mapping of the selected mapping information to the features.

In some embodiments, the confidence threshold (e.g., 90%, 95%, or 99%) is selected based on an environmental type. Image/video data of the environment is segmented to identify digital features associated with the environment. For example, identification is performed using the ML system 500 of FIG. 5. The digital features are part of the digital environment model. Via a VR device, one or more identification prompts are generated for receiving the environmental mapping information from the at least one user to label one or more discrete features viewed by the user. The discrete features associated with the environment can be identified using one or more ML algorithms.

System 100 includes a server 102 (or other computer system), where the computer system includes one or more non-transitory storage media storing program instructions to perform one or more operations of a projection module 122, a display module 123, or a feedback module 124. In some embodiments, system 100 includes wearable device 104, where the wearable device 104 may include one or more non-transitory storage media storing program instructions to perform one or more operations of the projection module 122, the display module 123, or the feedback module 124.

Wearable device 104 can be a VR headset, such as a head-mounted device that provides VR for the wearer. Wearable device 104 can be used in applications, including simulators and trainers for monitoring of behavior, activities, or other changing information. Wearable device 104 typically includes a stereoscopic display (providing separate images for each eye), stereo sound, and sensors like accelerometers and gyroscopes for tracking the pose of the user's head to match the orientation of the virtual camera with the user's eye positions in the real world. The user can be an employee of a retailer configuring an extended-reality environment or an end user viewing the extended-reality environment (e.g., a shopper). Wearable device 104 can also have eye-tracking sensors and controllers. Wearable device 104 can use head-tracking, which changes the field of vision as a user turns their head.

Wearable device 104 can include imagers, sensors, displays, feedback devices, controllers, or the like. The wearable device 104 can capture data, locally analyze data, and provide output to the user based on the data. A controller of the wearable device 104 can perform local computing (e.g., edge computing) with or without communicating with a remote server and can store edge computing ML libraries locally analyzing data to provide output. This allows onboard processing to be performed to avoid or limit the impact of, for example, network communications. Edge computing is a distributed computing paradigm that brings computation and data storage closer to the sources of data. This improves response times and saves bandwidth. Edge computing is an emerging computing paradigm which refers to a range of networks and devices at or near the user. Edge computing processes video data closer to the electronic devices, enabling processing at greater speeds and volumes, leading to greater action-led results in real time.

System 100 can include one or more wearable devices configured to be worn on other parts of the body. The wearable devices can include, for example, gloves (e.g., haptic feedback gloves or motion-tracking gloves), wearable glasses, loops, heart monitors, heart rate monitors, or the like. These wearable devices can communicate with components of the system 100 via wire connections, optical connections, wireless communications, etc. The wearable device 104 can also communicate with external sensors and equipment. The wearable device 104 can receive data (sensor output, equipment output, operational information for instruments, etc.) and display the received information to the user. This allows the user to view sensor data without turning their attention away from a monitoring site.

System 100 can include a set of external displays 105 (e.g., accessories of the wearable device 104, desktop monitors, television screens, or other external displays), where the set of external displays 105a, 105b may be provided instructions to display visual stimuli based on measurements or instructions provided by the wearable device 104 or the server 102. In some embodiments, the wearable device 104 may communicate with various other electronic devices via a network 150, where the network 150 may include the Internet, a local area network, a peer-to-peer network, etc.

The wearable device 104 may send and receive messages through the network 150 to communicate with a server 102, where the server 102 may include one or more non-transitory storage media storing program instructions to perform one or more operations of a statistical predictor. It should further be noted that while one or more operations are described herein as being performed by particular components of the system 100, those operations may be performed by other components of the system 100 in some embodiments. For example, operations described in this disclosure as being performed by the server 102 may instead be performed by the wearable device 104, where program code or data stored on the server 102 may be stored on the wearable device 104 or another client computer device instead. Similarly, in some embodiments, the server 102 may store program code or perform operations described as being performed by the wearable device 104. For example, the server may perform operations described as being performed by the projection module 122, the display module 123, or the feedback module 124. Furthermore, although some embodiments are described herein with respect to ML models, other prediction models (e.g., a statistical model) may be used instead of or in addition to ML models. For example, a statistical model may be used to replace a neural network model in one or more embodiments. An example ML system 500 is illustrated and described in more detail with reference to FIG. 5.

In some embodiments, the system 100 may present a set of stimuli (e.g., shapes, text, video, or images) on a display of the wearable device 104. The wearable device 104 may include a case 143, a left transparent display 141, and a right transparent display 142, where light may be projected from emitters of the wearable device through waveguides of the transparent displays 141-142 to present stimuli viewable by an eye(s) of a user wearing the wearable device 104. The wearable device 104 also includes a set of outward-facing sensors 147, where the set of outward-facing sensors 147 may provide sensor data indicating the physical space around the wearable device 104. In some embodiments, the set of outward-facing sensors 147 may include cameras, infrared sensors, lidar sensors, radar sensors, etc. In some embodiments, the sensors 147 can be inward-facing to monitor the user's state (e.g., level of stress, alertness level, etc.).

In some embodiments, the sensors 147 can be cameras that capture images of the environment, people, equipment, user, or the like. The captured images can be used to analyze steps being performed, the environment state, and/or the surrounding environment. This allows the system 100 to provide comprehensive analytics during procedures. For example, output from the sensors 147 of the wearable device 104 can be used to analyze the concentration/focus level of the user, alertness of the user, and stress level of the user (e.g., stress level calculated based on user metrics, such as heart rate, blood pressure, or breathing pattern), and other metrics. In some embodiments, if the user becomes unable to maintain a threshold level of focus, the system 100 can modify the processes described herein such that critical steps are performed by another user, a robotic system, or using alternative techniques.

In some embodiments, sensors 147 can track the wearer's eyes and provide feedback to the user to encourage the user to focus on targeted regions for visualization. This can help train the user to focus attention on regions or areas for actions or monitoring of behavior, activities, or other changing information. The wearable device 104 can receive and store plans, data, and other information sufficient to allow one or more security steps to be performed with or without remote communications. This ensures that security steps can be completed if there is communication failure at the environment.

In some procedures, the system 100 can develop one or more training simulations for a user. The user can perform the simulations for manual procedures, robotically assisted processes, or robotic processes (e.g., moving a camera or audio equipment). The system 100 can adaptively update the simulations based on desired procedure criteria, such as process time, predicted outcome, safety, outcome scores, or the like. This allows the system 100 to develop security plans suitable for the security procedures while training the user. In some embodiments, the wearable device 104 can collect user input to synchronize the user's input with a security procedure. For example, the system 100 can develop security plans with security steps for appropriate time periods based on threshold metrics. If the user becomes fatigued or tired, security steps can be shortened, reduced, or assigned to other users. Other users can use other wearable devices that are synchronized to communicate with the wearable device 104 to provide coordinated operation between users.

In some embodiments, system 100 receives an environment type. A digital environmental model is generated based on the environment type. The digital environmental model includes environmental information associated with a portion of the environmental features. For example, system 100 retrieves modeling parameters for generating the digital environmental model based on one or more security steps. The digital environmental model is generated according to the modeling parameters. The modeling parameters can include, for example, one or more parametric modeling parameters, model properties (e.g., thermal properties), fluid modeling parameters, mesh parameters (e.g., parameters for generating 3D meshes), kinematic parameters, boundary conditions, loading parameters, biomechanical parameters, fluid dynamic parameters, thermodynamic parameters, etc. The environmental features are identified within the digital environmental model. Environmental characteristics are assigned to the identified environmental features for viewing by the at least one user. The environmental characteristics can include, for example, one or more environmental feature statuses (e.g., crowded, sparse, high traffic), area properties, sizes of environmental features, etc.

In some embodiments, system 100 retrieves modeling parameters for generating the environmental model based on one or more security steps. The digital model is generated according to the modeling parameters. The environmental features are identified within the digital model. Environmental characteristics are assigned to the identified environmental features for viewing by the at least one user. For example, the modeling parameters define three-dimensional (3D) objects in an XR or AR environment that can be moved with a number of degrees of freedom (e.g., six degrees of freedom) using a controller (e.g., cursor). Modeling the identified features enables a user to experiment with perspective compared to traditional software.

The XR simulation environment can include polygonal modeling, e.g., connecting points in 3D space (vertices) by line segments to form a polygonal mesh. For example, the XR simulation environment includes textured polygonal meshes that are flexible and/or planar to approximate curved surfaces. In some embodiments, curve modeling (defining surfaces by curves that are influenced by weighted control points) is used. For example, performing security steps virtually on the digital model uses digital sculpting (also known as sculpt modeling or 3D sculpting) to cut, push, pull, smooth, grab, pinch or otherwise manipulate virtual features.

Generating the digital model is performed by developing a mathematical coordinate-based representation of different surfaces of the features in three dimensions by manipulating edges, vertices, and polygons in the simulated XR environment. The digital model represents the physical environment using a collection of points in 3D space, connected by different geometric entities such as lines and curved surfaces, etc. In embodiments, the digital model can be created by procedural modeling or scanning based on imaging methods. The digital model can also be represented as a 2D image using 3D rendering.

The AR mapping to the environment can include solid models that define a volume of the environmental feature they represent, mapped using constructive solid geometry. One or more correlations are determined between the environmental mapping information and at least one security state, e.g., at an oil and gas facility. A confidence-score AR mapping engine is updated based on the determination. The confidence-score AR mapping engine is configured to perform confidence-score AR mapping for other scenarios in new AR environments.

The environmental mapping information can include shells or boundaries that represent surfaces of the environmental features. The AR environment displayed to the at least one user can include polygonal meshes representing the physical features, subdivision surfaces, or level sets for deforming surfaces that can undergo topological changes. The AR mapping process can include transforming digital representations of the features into polygonal representations (polygon-based rendering) of the features overlaid on images of the physical features.

Furthermore, the system 100 may present stimuli on the set of external displays 105 during a visual testing operation. While the set of external displays 105 is shown with two external displays 105a, 105b, a set of external displays may include more or fewer external displays, such as only one external display or more than two external displays. For example, a set of external displays may include four external displays, eight external displays, nine external displays, or some other number of external displays. The external displays may include one or more types of electronic displays, such as computer monitors, smartphones, television screens, laptop devices, tablet devices, LED devices, LCD devices, and other types of electronic displays, etc. In some embodiments, the external display may include a projector, where the location of the external display may include a wall or screen onto which one or more stimuli is projected. In some embodiments, the external display may itself be transparent or partially transparent.

During or after a visual testing operation, the system 100 may obtain feedback information related to the set of stimuli, where the feedback information may indicate whether or how an eye responds to one or more stimuli of the set of stimuli. For example, some embodiments may use the wearable device 104 to collect feedback information that includes various eye-related characteristics. In some embodiments, the feedback information may include an indication of a response of an eye to the presentation of a dynamic stimulus at a first display location 146 on a wearable device 104. Alternatively, or in addition, the feedback information may include an indication of a lack of a response to such a stimulus. The response or lack of response may be determined based on one or more eye-related characteristics, such as an eye movement, a gaze direction, a distance in which an eye's gaze traveled in the gaze direction, a pupil size change, a user-specific input, etc. In some embodiments, the feedback information may include image data or results based on image data. For example, some embodiments may obtain an image or sequence of images (e.g., in the form of a video) of an eye captured during a testing operation as the eye responds to a stimulus.

In some embodiments, the system 100 may track the ocular data of an eye and update associated ocular information based on feedback information indicating eye responses to stimuli. Some embodiments may use a prediction model to detect a non-responsive region of a visual field or another ocular issue of a visual field portion associated with the ocular data. In some embodiments, satisfying a set of vision criteria for a visual field location may include determining whether an eye responded to a stimulus presented at the display location mapped to the visual field location, where different presented stimuli may vary in brightness, color, shape, size, etc.

In some embodiments, the system 100 can adjust viewing by the user based on the ocular information collected by the wearable device 104. Any number of simulations can be performed to generate ocular information suitable for determining optimal settings for a user. The settings can change throughout a security procedure based on security steps. For example, if the user becomes tired or fatigued, the system 100 can adjust the visual field to stimulate the user, thereby increasing attentiveness, e.g., in a war zone or combat scenario. In some embodiments, the user can adjust the stimuli to his or her preferred preferences. Other responses can be collected and associated with the security procedure, specific security steps, or the like. Feedback scores can be generated to rank the collected set of stimuli. The score can be based on the time to complete action, biometric levels of the user (e.g., state of stress or heart rate), or other metrics.

In some embodiments, data used or updated by one or more operations described in this disclosure may be stored in a set of databases 130. In some embodiments, the server 102, the wearable device 104, the set of external displays 105, or other computer devices may access the set of databases to perform one or more operations described in this disclosure. For example, a prediction model used to determine ocular information may be obtained from a first database 131, where the first database 131 may be used to store prediction models or parameters of prediction models. Alternatively, or in addition, the set of databases 130 may store feedback information collected by the wearable device 104 or results determined from the feedback information. For example, a second database 132 may be used to store a set of user profiles that include or link to feedback information corresponding with eye measurement data for the users identified by the set of user profiles. Alternatively, or in addition, the set of databases 130 may store instructions indicating different types of testing procedures. For example, a third database 133 may store a set of testing instructions that causes a first stimulus to be presented on the wearable device 104, then causes a second stimulus to be presented on a first external display 105a, and thereafter causes a third stimulus to be presented on a second external display 105b.

In some embodiments, the projection module 122 may generate a field-to-display map that maps a position or region of a visual field with a position or region of the set of external displays 105 or of an AR interface displayed on the left transparent display 141 or the right transparent display 142. The field-to-display map may be stored in various forms, such as in the form of a set of multi-dimensional arrays, a function, a subroutine, etc. For example, the field-to-display map may include a first multi-dimensional array, where the first two dimensions of the first array may indicate a coordinate in a combined display space that maps 1:1 with a visual field. In some embodiments, a third dimension of the first array may identify which external display or wearable display to use when presenting a stimulus. Furthermore, a fourth and fifth dimension of the array may be used as coordinates relative to the origin of each respective external display. In some embodiments, an array or other set of numbers described in this disclosure may instead be divided into a plurality of arrays or other subsets of numbers. In some embodiments, the field-to-display map may be used in reverse, such that a display location may be mapped to a visual field location (“field location”) using the field-to-display map. Some embodiments pre-generate a display-to-field map by inverting one or more of the arrays described above. Furthermore, some embodiments may use or update a map by using an array or other data structure of the map. Various other embodiments of the field-to-display map are possible, as described elsewhere in this disclosure.

In some embodiments, the projection module 122 may obtain sensor information from the set of outward-facing sensors 147, where the sensor information may include position measurements of the set of external displays 105. For example, a user wearing the wearable device 104 may rotate or translate their head, which may cause a corresponding rotation or translation of the wearable device 104. Some embodiments may detect these changes in the physical orientation or position of the wearable device 104 with respect to the set of external displays 105. Some embodiments may then perform a mapping operation to determine the positions and orientations of the set of external displays based on the sensor information collected by the set of outward-facing sensors 147.

In some embodiments, the projection module 122 may update a field-to-display map that stores or otherwise indicates associations between field locations of a visual field and display locations of the left transparent display 141, the right transparent display 142, or the set of external displays 105. For example, the set of outward-facing sensors 147 may include one or more cameras to collect visual information from a surrounding area of the wearable device 104, where the visual information may be used to determine a position or orientation of one or more devices of the set of external displays 105. As the wearable device 104 is moved, some embodiments may continuously obtain sensor information indicating changes to the external environment, including changes in the position or orientation of the set of external displays 105 relative to the position or orientation of the wearable device 104. For example, some embodiments may generate a point cloud representing the surfaces of objects around the wearable device 104 and determine the positions and orientations of the set of external displays 105 relative to the wearable device 104 based on the point cloud. Furthermore, some embodiments may continuously update the field-to-display map as new sensor information is collected by the set of outward-facing sensors 147.

In some embodiments, the display module 123 may present a set of stimuli on the wearable device 104 or the set of external displays 105. In some embodiments, the left transparent display 141 and right transparent display 142 may be positioned with respect to the case 143 to fit an orbital area on a user such that each display of the transparent displays 141-142 is able to collect data and present stimuli or other images to the user. The left transparent display 141 and right transparent display 142 may contain or be associated with an electronic display configured to present re-created images to an eye viewing the respective transparent display. In various embodiments, electronic display may include a projector, display screen, and/or hardware to present an image viewable by the eye. In some embodiments, a projector of an electronic monitor may be positioned to project images onto an eye of the subject or onto or through a screen, glass, waveguide, or other material. For example, the display module 123 may cause a fixation point or another visual stimulus to be projected onto the first display location 146, where the fixation point at the first display location 146 may then be viewed by an eye of a user wearing the wearable device 104.

In some embodiments, the display module 123 may cause a set of stimuli to be displayed onto electronic displays other than the displays of the other external displays, such as an external display of the set of the external displays 105. For example, after presenting a stimulus on a display of the wearable device 104, the display module 123 may cause a stimulus to be presented on the second external display 105b at a second display location 151. As used in this disclosure, an external display location may include a display location on an external display. The display module 123 may then proceed to display additional stimuli on an additional location of the first external display 105a, the wearable device 104, or the second external display 105b.

Some embodiments may determine the display location for a stimulus by first determining the location or region of a visual field. After determining the location or region of the visual field, some embodiments may then use a field-to-display map to determine which display location of the left transparent display 141, the right transparent display 142, or the set of external displays 105 to use when displaying a stimulus. For example, some embodiments may determine that a previous sequence of sensor measurements indicated that a first region of a visual field has not yet been tested and select this first region for testing. Some embodiments may then use the field-to-display map to determine a third display location 152 on the first external display 105a and, in response to selecting the third display location 152, display a stimulus at the third display location 152. As described elsewhere in this disclosure, some embodiments may measure eye movements or otherwise measure responses of an eye to the stimuli presented on the set of external displays 105 to measure a visual field of the eye. Furthermore, as described in this disclosure, a visual field location of a stimulus may include the field location mapped to or otherwise associated with the display location of the stimulus, where the mapping or association between the display and the field location is determined by a field-to-display map. Similarly, as used in this disclosure, a gaze location that is located at a field location may also be described as being located at a display location mapped to the field location.

In some embodiments, the feedback module 124 may record feedback information indicating eye responses to the set of stimuli presented on the wearable device 104 or the set of external displays 105. In some embodiments, the transparent displays 141-142 may include a left inward-directed sensor 144 and a right inward-directed sensor 145, where the inward-directed sensors 144-145 may include eye-tracking sensors. The inward-directed sensors 144-145 may include cameras, infrared cameras, photodetectors, infrared sensors, etc. For example, the inward-directed sensors 144-145 may include cameras configured to track pupil movement and determine and track the visual axes of the subject. In some embodiments, the inward-directed sensors 144-145 may include infrared cameras and be positioned in lower portions relative to the transparent displays 141-142. The inward-directed sensors 144-145 may be directionally aligned to point toward a presumed pupil region for line-of-sight tracking or pupil tracking.

In some embodiments, the feedback module 124 may use the inward-directed sensors 144-145 to collect feedback information indicating eye motion as an eye responds to different stimuli. For example, the feedback module 124 may retrieve feedback information of an eye collected by the inward-directed sensors 144-145 as the eye responds to the presentation of a stimulus at the first display location 146 and the second display location 151. By collecting feedback information while stimuli are presented on both the wearable device 104 and one or more devices of the set of external displays 105, some embodiments may increase the boundaries of a visual field for which ocular data may be detected.

In some embodiments, the statistical predictor 125 may retrieve stimuli information, such as stimuli locations and characteristics of the stimuli locations, where the stimuli locations may include locations on the set of external displays 105. The statistical predictor 125 may also retrieve training outputs indicative of the presence or absence of ocular responses or other outputs of a prediction model. The statistical predictor 125 may then provide the set of stimuli information and training outputs to a ML model to update the parameters of the ML model to predict ocular responses based on new inputs. An example ML system 500 is illustrated and described in more detail with reference to FIG. 5. Alternatively, or in addition, the statistical predictor 125 may use statistical models or rules to determine ocular responses and generate a visual field map representing a visual field of an eye, where one or more regions of the visual field map may be associated with a set of ocular responses or otherwise include ocular response information.

FIG. 2 illustrates an XR head-mounted display (HMD) 200, in accordance with one or more embodiments. HMD 201 can be, for example, an augmented reality device worn by a user while the user views a particular environment. Information can be displayed at selected locations to avoid obstructing the viewing of targeted areas. A user 295 (e.g., a shopper) can wear HMD 201, which can include a computing device 207. Computing device 207 can include a processor, microprocessor, controller, or other circuitry. In some embodiments, an eye 296 of the user may be capable of viewing images and video in XR from the operating room 202 through lenses 270 of the HMD 201. The HMD 201 may include an interior-facing camera to capture eye-related information and a set of exterior-facing cameras that include an exterior-facing camera 282.

In some embodiments, a user initiates an XR session using computing system 280 that is in communication with the HMD 201. Computing system 280 may include a stand-alone computer capable of operating without connecting to another computing device outside of a local network. Alternatively, or in addition, the computing system 280 may include a computing system that receives program instructions or required data from an external data source not available through a local network.

In some embodiments, the computing system 280 may initiate an XR session. Computing system 280 may communicate with the HMD 201 via a wireless connection or wired connection. For example, the computing system 280 may send a wireless message to the computing device 207 to initiate an XR session. For example, the computing system 280 may send a command to the HMD 201 via a Bluetooth® connection, where the command may cause the HMD 201 to activate.

In some embodiments, the computing system 280 may communicate with the HMD 201 to perform one or more operations. For example, the HMD 201 may present an initial set of instructions to user 295 and request a response from user 295. After user 295 provides a requested response (e.g., pressing a button, making a statement, etc.), the computing system 280 may send a first set of instructions to the HMD 201 to calibrate readings to more accurately measure eye-related data associated with the eye 296. After the HMD 201 sends a message to the computing system 280 that calibration operations have been completed, the computing system 280 may send further instructions to the HMD 201. The computing system 280 may determine the position of a fixation point based on eye-related readings and send a message to the HMD 201 that causes the HMD 201 to display a visual stimulus at the fixation point on the lenses 270. After receiving a message from the HMD 201 that the eye 296 has set its gaze at the fixation point, the computing system 280 may continue the XR session.

In some embodiments, an application executed by the computing device 207 of the HMD 201 may be used to control operations of components of the HMD 201 or other electronic components. For example, the application executed by computing device 207 may begin a visual test program and send a wireless message to a circuitry of the system 280 using a wireless headset communication subsystem 203. The wireless message may be based on one of various types of communication standards, such as a Bluetooth® standard, a Wi-Fi Direct standard, a near-field communication (NFC) standard, a ZigBee® standard, a 6LoWPAN standard, etc.

In some embodiments, an application being executed by the computing device 207 may retrieve data from the interior-facing camera 283 and send instructions to control equipment based on this data. For example, the computing device 207 may execute an application to perform a Viola-Jones object detection framework to detect an eye in a set of images using a boosted feature classifier based on video data provided by the interior-facing camera 283. Furthermore, the application executed by the computing device 207 may permit additional sensor data to trigger equipment in a room 202, such as by receiving voice instructions captured from a microphone 281, motion detected by the exterior-facing camera 282, feeling a set of touches on the housing of the HMD 201, etc.

In some embodiments, a testing application executed by the computing device 207 detects that a gaze location of user 295 is focused on a target user interface (UI) element or a target direction based on data collected by interior-facing camera 283. For example, HMD 201 displays a set of instructions that causes user 295 to look at a target UI location. In some embodiments, the target UI location is represented by a target region associated with the target UI location, such that a gaze location determined to be within the target region is considered to be focused on the target UI location. In response to a determination that the gaze location of eye 296 is focused on the target UI location based on images provided by the interior-facing camera 283, the application can activate equipment 232. Furthermore, the application can send a message to a robotic system 211 to turn off equipment 232 based on a determination that the target UI location is no longer a focus of the user's gaze. Alternatively, some embodiments may forego waiting for user 295 to focus on a particular UI location or a particular direction before activating the equipment 232.

In additional embodiments, a computer system obtains environmental data, e.g., from a camera. A user-mapping program is used to train an intra-operative AR mapping platform based on the obtained data (audio, images, video, etc.). For example, the user-mapping program is configured to receive user input for the identification of environmental features/objects. One or more environmental features are identified based on the obtained data. The computer system performs an intra-operative AR mapping of the identified one or more features using the trained intra-operative AR mapping platform. Via an AR device, the intra-operative AR mapping is displayed to be viewed by a user.

In some embodiments, performing the intra-operative AR mapping includes determining one or more features to be identified. The one or more features are identified. The one or more features and associated information are labeled. For example, one or more unidentifiable features are marked. In some embodiments, an autonomous mapping platform is used to perform the intra-operative AR mapping. The autonomous mapping platform is trained by multiple users inputting data for reference images and validated for autonomously mapping a set of features associated with an environment.

In some embodiments, a computer system selects one or more candidate features of a virtual environmental model in a VR environment displayed to a user. For example, the candidate features can be edges, points, or object parts. User input is received for the selected one or more candidate features. The computer system determines whether the user input for one or more candidate features reaches a threshold confidence score. In response to the user input reaching the threshold confidence score, the user input is identified as accurately labeling the one or more candidate features. In some embodiments, a computer system stores the user input as reference label data for the corresponding one or more candidate features. For example, the user input includes a label for each one of the respective one or more candidate features.

In some embodiments, determining whether the user input for one or more candidate features reaches the threshold confidence score is based on a comparison reference user input for similar candidate features. For example, the user input is used to train a ML model. For each of the candidate features, the user input can include at least one of a name of the candidate feature or user annotation.

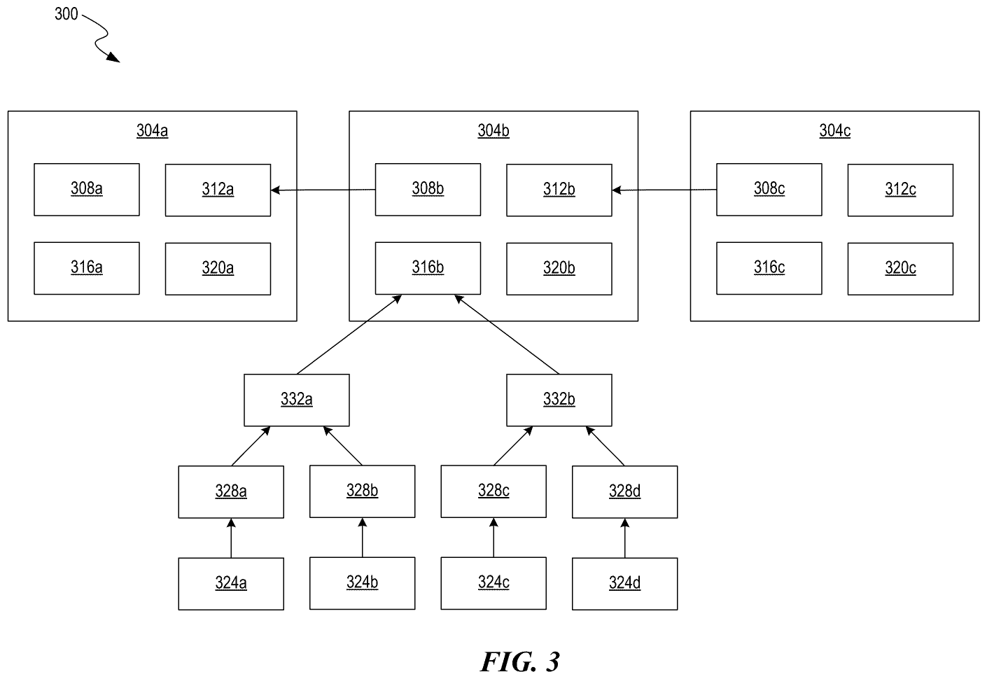

FIG. 3 is a block diagram illustrating components of at least a portion of an example blockchain system 300, in accordance with one or more embodiments of this disclosure. Blockchain system 300 includes blockchain 304. In embodiments, the blockchain 304 is a distributed ledger of transactions (e.g., a continuously growing list of records, such as records of transactions for digital assets such as cryptocurrency, bitcoin, or electronic cash) that is maintained by a blockchain system 300. For example, the blockchain 304 is stored redundantly at multiple nodes (e.g., computers) of a blockchain network. Each node in the blockchain network can store a complete replica of the entirety of blockchain 304. In some embodiments, the blockchain system 300 implements storage of an identical blockchain at each node, even when nodes receive transactions in different orderings. The blockchain 304 shown by FIG. 3 includes blocks such as block 304a, block 304b, and/or block 304c. Likewise, embodiments of the blockchain system 300 can include different and/or additional components or be connected in different ways.

The terms “blockchain” and “chain” are used interchangeably herein. In embodiments, the blockchain 304 is a distributed database that is shared among the nodes of a computer network. As a database, the blockchain 304 stores information electronically in a digital format. The blockchain 304 can maintain a secure and decentralized record of transactions (e.g., transactions such as transaction 324a and/or transaction 324b). For example, the ERC-721 or ERC-1155 standards are used for maintaining a secure and decentralized record of transactions. The blockchain 304 provides fidelity and security for the data record. In embodiments, blockchain 304 collects information together in groups, known as “blocks” (e.g., blocks such as block 304a, block 304b, and/or block 304c) that hold sets of information.

The blockchain 304 structures its data into chunks (blocks) (e.g., blocks such as block 304a, block 304b, and/or block 304c) that are strung together. Blocks (e.g., block 304c) have certain storage capacities and, when filled, are closed and linked to a previously filled block (e.g., block 304b), forming a chain of data known as the “blockchain.” New information that follows a freshly added block (e.g., block 304b) is compiled into a newly formed block (e.g., block 304c) that will then also be added to the blockchain 304 once filled. The data structure inherently makes an irreversible timeline of data when implemented in a decentralized nature. When a block is filled, it becomes a part of this timeline of blocks. Each block (e.g., block 304a) in the blockchain system 300 is given an exact timestamp (e.g., timestamp 312a) when it is added to the blockchain system 300. In the example of FIG. 3, blockchain system 300 includes multiple blocks. Each of the blocks (e.g., block 304a, block 304b, block 304c) can represent one or multiple transactions and can include a cryptographic hash of the previous block (e.g., previous hashes 308a-c), a timestamp (e.g., timestamps 312a-c), a transactions root hash (e.g., 316a-c), and a nonce (e.g., 320a-c). A transactions root hash (e.g., transactions root hash 316b) indicates the proof that the block 304b contains all the transactions in the proper order. Transactions root hash 316b proves the integrity of transactions in the block 304b without presenting all transactions.

In embodiments, the timestamp 312a-c of each of corresponding blocks of block 304a, block 304b, block 304c includes data indicating a time associated with the block. In some examples, the timestamp includes a sequence of characters that uniquely identifies a given point in time. In one example, the timestamp of a block includes the previous timestamp in its hash and enables the sequence of block generation to be verified.

In embodiments, nonces 320a-c of each of corresponding blocks of block 304a, block 304b, block 304c include any generated random or semi-random number. The nonce can be used by miners during proof of work (PoW), which refers to a form of adding new blocks of transactions to blockchain 304. The work refers to generating a hash that matches the target hash for the current block. For example, a nonce is an arbitrary number that miners (e.g., devices that validate blocks) can change in order to modify a header hash and produce a hash that is less than or equal to the target hash value set by the network.

As described above, each of blocks of block 304a, block 304b, block 304c of blockchain 304 can include respective block hash, e.g., transactions root hash 316a, transactions root hash 316b, and transactions root hash 316c. Each of block hashes 316a-c can represent a hash of a root node of a Merkle tree for the contents of the block (e.g., the transactions of the corresponding block). For example, the Merkle tree contains leaf nodes corresponding to hashes of components of the transaction, such as a reference that identifies an output of a prior transaction that is input to the transaction, an attachment, and a command. Each non-leaf node can contain a hash of the hashes of its child nodes. The Merkle tree can also be considered to have each component as the leaf node with its parent node corresponding to the hash of the component.

In the example of FIG. 3, block 304b records transactions 324a-d. Each of the leaf nodes 328a-d contain a hash corresponding to transactions 324a-d respectively. As described above, a hash (e.g., the hash in leaf node such as node 328a) can be a hash of components of a transaction (e.g., transaction 324a), for example, a reference that identifies an output of a prior transaction that is input to the transaction 324a, an attachment, and a command. Each of the non-leaf nodes of node 332a and node 332b can contain a hash of the hashes of its child nodes (e.g., leaf nodes such as node 328a and node 328b). In this example, node 332a can contain a hash of the hashes contained in node 328a, node 328b and node 332b can contain a hash of the hashes contained in node 328c, node 328d. The root node, which includes (e.g., contains) transactions root hash 316b, can contain a hash of the hashes of child nodes 332a-b.

A Merkle tree representation of a transaction (e.g., transaction 324a) allows an entity needing access to the transaction 324a to be provided with only a portion that includes the components that the entity needs. For example, if an entity needs only the transaction summary, the entity can be provided with the nodes (and each node's sibling nodes) along the path from the root node to the node of the hash of the transaction summary. The entity can confirm that the transaction summary is that used in the transaction 324a by generating a hash of the transaction summary and calculating the hashes of the nodes along the path to the root node. If the calculated hash of the root node matches the hash of node 328a of the transaction 324a, the transaction summary is confirmed as the one used in the transaction. Because only the portion of the Merkle tree relating to components that an entity needs is provided, the entity will not have access to other components. Thus, the confidentiality of the other components is not compromised.

To transfer ownership of a digital asset, such as a bitcoin, using the blockchain system 300, a new transaction, such as one of transactions 324a-d, is generated and added to a stack of transactions in a block, e.g., block 304b. To record a transaction in a blockchain, each party and asset involved with the transaction needs an account that is identified by a digital token. For example, when a first user wants to transfer an asset that the first user owns to a second user, the first and second user both create accounts, and the first user also creates an account that is uniquely identified by the asset's identification number. The account for the asset identifies the first user as being the current owner of the asset. The first user (i.e., the current owner) creates a transaction (e.g., transaction 324a) against the account for the asset that indicates that the transaction 324a is a transfer of ownership and outputs a token identifying the second user as the next owner and a token identifying the asset. The transaction 324a is signed by the private key of the first user (i.e., the current owner), and the transaction 324a is evidence that the second user is now the new current owner and that ownership has been transferred from the first to the second user.

The transaction 324a (e.g., a new transaction), which includes the public key of the new owner (e.g., a second user to whom a digital asset is assigned ownership in the transaction), is digitally signed by the first user with the first user's private key to transfer ownership to the second user (e.g., new owner), as represented by the second user public key. The signing by the owner of the bitcoin is an authorization by the owner to transfer ownership of the bitcoin to the new owner via the transaction 324a (e.g., the new transaction). Once the block is full, the block is “capped” with a block header, that is, a hash digest of all the transaction identifiers within the block. The block header is recorded as the first transaction in the next block in the chain, creating a mathematical hierarchy called the “blockchain.” To verify the current owner, the blockchain 304 of transactions can be followed to verify each transaction from the first transaction to the last transaction. The new owner need only have the private key that matches the public key of the transaction that transferred the bitcoin. The blockchain creates a mathematical proof of ownership in an entity represented by a security identity (e.g., a public key), which in the case of the bitcoin system is pseudo-anonymous.

Additionally, in some embodiments, the blockchain system 300 uses one or more smart contracts to enable more complex transactions. A smart contract includes computer code implementing transactions of a contract. The computer code can be executed on a secure platform (e.g., an Ethereum platform, which provides a virtual machine) that supports recording transactions (e.g., 324a-d) in blockchains. For example, a smart contract can be a self-executing contract with the terms of the agreement between buyer and seller being directly written into lines of code. The code and the agreements contained therein exist across a distributed, decentralized blockchain network.

In addition, the smart contract can itself be recorded as a transaction 324a in the blockchain 304 using a token that is a hash of node 328a of the computer code so that the computer code that is executed can be authenticated. When deployed, a constructor of the smart contract executes, initializing the smart contract and its state. The state of a smart contract is stored persistently in the blockchain 304. When a transaction 324a is recorded against a smart contract, a message is sent to the smart contract, and the computer code of the smart contract executes to implement the transaction (e.g., debit a certain amount from the balance of an account). The computer code ensures that all the terms of the contract are complied with before the transaction 324a is recorded in the blockchain 304.

For example, a smart contract can support the sale of an asset. The inputs to a smart contract to sell an asset can be tokens identifying the seller, the buyer, the asset, and the sale price in U.S. dollars or cryptocurrency. The computer code is used to ensure that the seller is the current owner of the asset and that the buyer has sufficient funds in their account. The computer code records a transaction (e.g., transaction 324a) that transfers the ownership of the asset to the buyer and a transaction (e.g., transaction 324b) that transfers the sale price from the buyer's account to the seller's account. If the seller's account is in U.S. dollars and the buyer's account is in Canadian dollars, the computer code can retrieve a currency exchange rate, determine how many Canadian dollars the seller's account should be debited, and record the exchange rate. If either of transaction 324a or transaction 324b is not successful, neither transaction is recorded.

When a message is sent to a smart contract to record a transaction 324a, the message is sent to each node that maintains a replica of the blockchain 304. Each node executes the computer code of the smart contract to implement the transaction 324a. For example, if a hundred nodes each maintain a replica of the blockchain 304, the computer code executes at each of the hundred nodes. When a node completes execution of the computer code, the result of the transaction 324a is recorded in the blockchain 304. The nodes employ a consensus algorithm to decide which transactions (e.g., transaction 324c) to keep and which transactions (e.g., transaction 324d) to discard. Although the execution of the computer code at each node helps ensure the authenticity of the blockchain 304, large amounts of computer resources are required to support such redundant execution of computer code.

Although blockchains can effectively store transactions 324a-d, the large amount of computer resources, such as storage and computational power, needed to maintain all the replicas of the blockchain can be problematic. To overcome this problem, some systems for storing transactions 324a-d do not use blockchains, but rather have each party to a transaction maintain its own copy of the transaction 324a. One such system is the Corda™ system developed by R3™ that provides a decentralized distributed ledger platform in which each participant in the platform has a node (e.g., computer system) that maintains its portion of the distributed ledger.

When parties agree on the terms of a transaction 324a, a party submits the transaction 324a to a notary, which is a trusted node, for notarization. The notary maintains a consumed output database of transaction outputs that have been input into other transactions. When a transaction 324a is received, the notary checks the inputs to the transaction 324a against the consumed output database to ensure that the outputs that the inputs reference have not been spent. If the inputs have not been spent, the notary updates the consumed output database to indicate that the referenced outputs have been spent, notarizes the transaction 324a (e.g., by signing the transaction or a transaction identifier with a private key of the notary), and sends the notarized transaction to the party that submitted the transaction 324a for notarization. When the party receives the notarized transaction, the party stores the notarized transaction and provides the notarized transaction to the counterparties.

In embodiments, a notary is a non-validating notary or a validating notary. When a non-validating notary is to notarize a transaction (e.g., transaction 324b), the non-validating notary determines that the prior output of a prior transaction (e.g., transaction 324a), that is, the input of a current transaction, e.g., transaction 324b, has not been consumed. If the prior output has not been consumed, the non-validating notary notarizes the transaction 324b by signing a hash of node 328b of the transaction. To notarize a transaction 324b, a non-validating notary needs only the identification of the prior output (e.g., the hash of node 328a of the prior transaction (e.g., transaction 324a) and the index of the output) and the portion of the Merkle tree needed to calculate the hash of node 328b of the transaction 324b.

As described herein, in some embodiments, the blockchain system 300 uses one or more smart contracts to enable more complex transactions. For example, a validating notary validates a transaction (e.g., transaction 324d), which includes verifying that prior transactions 324a-c in a backchain of transactions are valid. The backchain refers to the collection of prior transactions (e.g., transaction 324c) of a transaction 324d, as well as prior transactions of transaction 324a, transaction 324b, and transaction 324c, and so on. To validate a transaction 324d, a validating notary invokes validation code of the transaction 324d. In one example, a validating notary invokes validation code of a smart contract of the transaction 324d. The validation code performs whatever checks are needed to comply with the terms applicable to the transaction 324d. This checking can include retrieving the public key of the owner from the prior transaction (e.g., transaction 324c) (pointed to by the input state of the transaction 324d) and checks the signature of the transaction 324d, ensuring that the prior output of a prior transaction that is input has not been consumed, and checking the validity of each transaction (e.g., transaction 324c) in the backchain of the transactions. If the validation code indicates that the transaction 324d is valid, the validating notary notarizes the transaction 324d and records the output of the prior transaction (e.g., transaction 324c) as consumed.

In some examples, to verify that the transactions 324a-d in a ledger stored at a node are correct, the blocks, e.g., block 304a, block 304b, block 304c in the blockchain 304 can be accessed from oldest block (e.g., block 304a) to newest block (e.g., block 304c), generating a new hash of the block 304c and comparing the new hash to the hash 308c generated when the block 304c was created. If the hashes are the same, then the transactions in the block are verified. In one example, the Bitcoin system also implements techniques to ensure that it would be infeasible to change a transaction 324a and regenerate the blockchain 304 by employing a computationally expensive technique to generate a nonce 320b that is added to the block when it is created. A bitcoin ledger is sometimes referred to as an Unspent Transaction Output (“UTXO”) set because it tracks the output of all transactions that have not yet been spent.

In some embodiments, a self-sovereign identity (SSI) approach to digital identity is used that gives individuals control over the information they use to prove who they are to websites, services, and applications across the web. For example, a head-mounted display (e.g., HMD 200 of FIG. 2) or a computer system implements an SSI protocol or SSI system to authenticate a user's credentials. In an SSI system, the user accesses services in a streamlined and secure manner, while maintaining control over the information associated with their identity. SSI addresses the difficulty of establishing trust in an interaction. In order to be trusted, one party in an interaction will present credentials to the other parties, and those relying on parties can verify that the credentials came from an issuer that they trust. In this way, the verifier's trust in the issuer is transferred to the credential holder. This basic structure of SSI with three participants is sometimes called “the trust triangle”. For an identity system to be self-sovereign, users control the verifiable credentials that they hold and their consent is required to use those credentials. This reduces the unintended sharing of users' personal data.

In an SSI system, holders generate and control unique identifiers called decentralized identifiers. Most SSI systems are decentralized, where the credentials are managed using crypto wallets and verified using public-key cryptography anchored on a distributed ledger. The credentials may contain data from an issuer's database, a social media account, a history of transactions on an e-commerce site, or attestation from friends or colleagues.

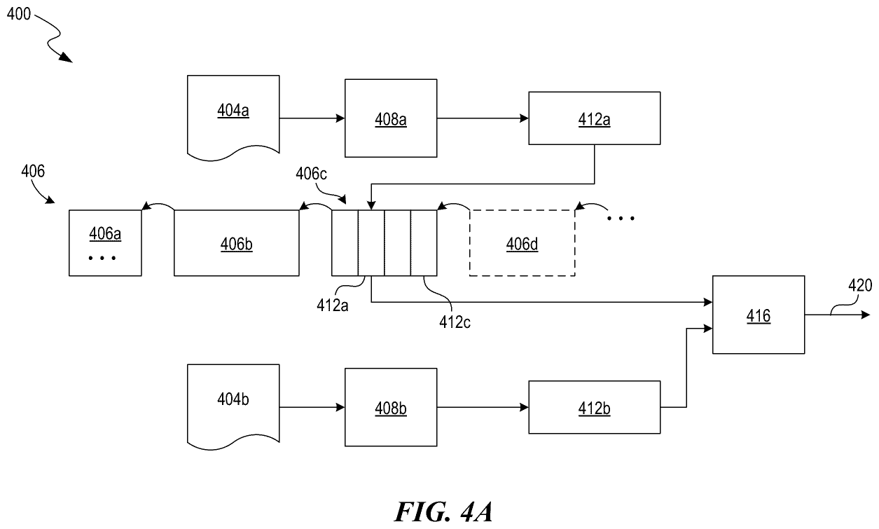

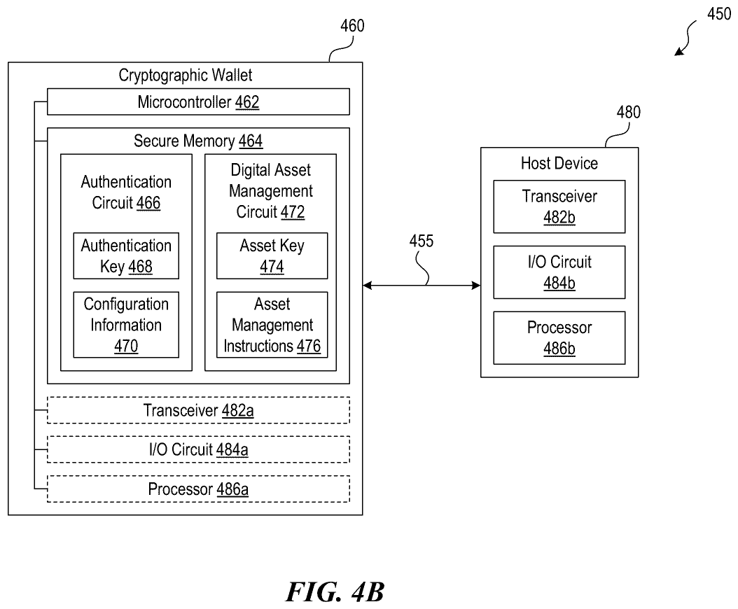

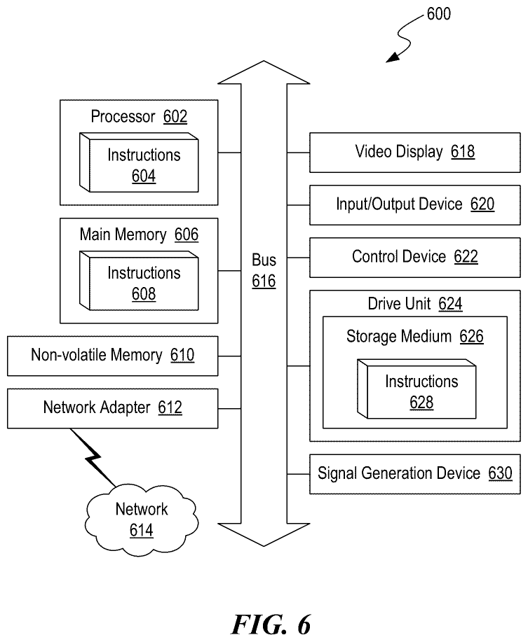

FIG. 4A is a drawing illustrating an example hash algorithm. The process 400 shown by FIG. 4A uses a hash algorithm to generate a token or perform a cryptographic transaction on a blockchain. An example blockchain 406, e.g., as shown in FIG. 4A, is also illustrated and described in detail with reference to FIG. 3. The process 400 can be performed by a computer system such as that described with reference to FIG. 6 and/or by nodes of the blockchain 406. Some embodiments include different and/or additional steps or perform steps in different orders.

In embodiments, a digital message, electronic art, a digital collectible, any other form of digital content, or a combination thereof (e.g., digital content 404a) can be hashed using hashing algorithm 408a. The hashing algorithm 408a (sometimes referred to as a “hash function”) can be a function used to map data of arbitrary size (e.g., digital content 404a) to fixed-size values (e.g., hash of values 412a). The values 412a that are returned by the hashing algorithm 408a can be called hash values, hash codes, digests, or hashes. The values 412a can be used to index a fixed-size table called a hash table. A hash table, also known as a hash map, is a data structure that implements an associative array or dictionary, which is an abstract data type that maps keys (e.g., digital content 404a) to values 412a.

The output of the hashed digital content (e.g., hash of values 412a) can be inserted into a block (e.g., block 406c) of the blockchain 406 (e.g., comprising blocks such as blocks such as block 406a, block 406b, block 406c, block 406d, and so on). The block 406c can include, among other things, information such as timestamp 412c. In order to verify that the block 406c is correct, a new hash 412b is generated by applying hashing algorithm 408b to the digital content 404b. The new hash 412b is compared to the hash of values 412a in the blockchain 406 at comparison step 416. If the new hash 412b is the same as the hash of values 412a of the block 406c, the comparison yields an indication that they match. For example, the decision 420 can indicate that the hashes of values 412a-b are the same or not. The hashes can be indicated to be the same if the characters of the hash match. The hashing algorithms 408a-b can include any suitable hashing algorithm. Examples include Message Digest 5 (MD5), Secure Hashing Algorithm (SHA) and/or the likes.

Components of the process 400 can generate or validate an NFT, which is a cryptographic asset that has a unique identification code and metadata that uniquely identifies the NFT. In one example, the digital content 404a can be hashed and minted to generate an NFT, or the digital content 404a can represent an NFT that is verified using the process 400 and the digital content 404b. An NFT can include digital data stored in the blockchain 406. The ownership of an NFT is recorded in the blockchain 406 and transferrable by an owner, allowing the NFT to be sold and traded. The NFT contains a reference to digital files such as photos, videos, or audio (e.g., digital content 404a). Because NFTs are uniquely identifiable assets, they differ from cryptocurrencies, which are fungible. In particular, NFTs function like cryptographic tokens, but unlike cryptocurrencies such as Bitcoin™ or Ethereum™, NFTs are not mutually interchangeable, and so are not fungible.

The NFT can be associated with a particular digital or physical asset such as images, art, music, and sport highlights and can confer licensing rights to use the asset for a specified purpose. As with other assets, NFTs are recorded on a blockchain when a blockchain 406 concatenates records containing cryptographic hashes-sets of characters that identify a set of data-onto previous records, creating a chain of identifiable data blocks such as block 406a, block 406b, block 406c, and block 406d. A cryptographic transaction process enables authentication of each digital file by providing a digital signature that tracks NFT ownership. In embodiments, a data link that is part of the NFT records points to details about where the associated art is stored.

Minting an NFT can refer to the process of turning a digital file (e.g., digital content 404a) into a crypto collectible or digital asset on blockchain 406 (e.g., the Ethereum™ blockchain). The digital item or file (e.g., digital content 404a) can be stored in the blockchain 406 and cannot be able to be edited, modified, or deleted. The process of uploading a specific item onto the blockchain 406 is known as “minting.” For example, “NFT minting” can refer to a process by which a digital art or digital content 404a becomes a part of the Ethereum™ blockchain. Thus, the process turns digital content 404a into a crypto asset, which is easily traded or bought with cryptocurrencies on a digital marketplace without an intermediary.

FIG. 4B is a block diagram 450 illustrating an example cryptographic wallet 460. As a general overview, cryptographic wallet 460 is an electronic entity that allows users to securely manage digital assets. According to various embodiments, the cryptographic wallet 460 can be a hardware-based wallet (e.g., can include dedicated hardware component(s)), a software-based wallet, or a combination thereof. Example digital assets that can be stored and managed using the cryptographic wallet 460 include digital coins, digital tokens, and/or the like. In some embodiments, tokens are stored on a blockchain system, such as the blockchain system 300 described in FIG. 3. In some embodiments, the cryptographic wallet 460 may be capable of connecting to and managing assets that are native to or associated with multiple, different blockchain systems (e.g., including multiple blockchain systems having structure similar to or equivalent to blockchain system 300).

As defined herein, the terms “coin” and “token” refer to a digital representation of a particular asset, utility, ownership interest, and/or access right. Any suitable type of coin or token can be managed using various embodiments of the cryptographic wallet 460. In some embodiments, tokens include cryptocurrency, such as exchange tokens and/or stablecoins. Exchange tokens and/or stablecoins can be native to a particular blockchain system and, in some instances, can be backed by a value-stable asset, such as fiat currency, precious metal, oil, or another commodity. In some embodiments, tokens are utility tokens that provide access to a product or service rendered by an operator of the blockchain system 300 (e.g., a token issuer). In some embodiments, tokens are security tokens, which can be securitized cryptocurrencies that derive from a particular asset, such as bonds, stocks, real estate, and/or fiat currency, or a combination thereof, and can represent an ownership right in an asset or in a combination of assets.

In some embodiments, tokens are NFTs or other non-fungible digital certificates of ownership. In some embodiments, tokens are decentralized finance (DeFi) tokens. DeFi tokens can be used to access feature sets of DeFi software applications (dApps) built on the blockchain system 300. Example dApps can include decentralized lending applications (e.g., Aave), decentralized cryptocurrency exchanges (e.g., Uniswap), decentralized NFT marketplaces (e.g., OpenSea, Rarible), decentralized gaming platforms (e.g., Upland), decentralized social media platforms (e.g., Steemit), decentralized music streaming platforms (e.g., Audius), and/or the like. In some embodiments, tokens provide access rights to various computing systems and can include authorization keys, authentication keys, passwords, PINs, biometric information, access keys, and other similar information. The computing systems to which the tokens provide access can be both on-chain (e.g., implemented as dApps on a particular blockchain system) or off-chain (e.g., implemented as computer software on computing devices that are separate from the blockchain system 300).

As shown, the cryptographic wallet 460 of FIG. 4B is communicatively coupled to the host device 480 (e.g., a mobile phone, a laptop, a tablet, a desktop computer, a wearable device, a point-of-sale (POS) terminal, an automated teller machine (ATM) and the like) via the communications link 455. In some embodiments, the host device 480 can extend the feature set available to the user of the cryptographic wallet 460 when it is coupled to the host device 480. For instance, the host device may provide the user with the ability to perform balance inquiries, convert tokens, access exchanges and/or marketplaces, perform transactions, access computing systems, and/or the like.

In some embodiments, the cryptographic wallet 460 and the host device 480 can be owned and/or operated by the same entity, user, or a group of users. For example, an individual owner of the cryptographic wallet 460 may also operate a personal computing device that acts as a host device 480 and provides enhanced user experience relative to the cryptographic wallet 460 (e.g., by providing a user interface that includes graphical features, immersive reality experience, virtual reality experience, or similar). In some embodiments, the cryptographic wallet 460 and the host device 480 can be owned and/or operated by different entities, users and/or groups of users. For example, the host device 480 can be a point-of-sale (POS) terminal at a merchant location, and the individual owner of the cryptographic wallet 460 may use the cryptographic wallet 460 as a method of payment for goods or services at the merchant location by communicatively coupling the two devices for a short period of time (e.g., via chip, via near-field communications (NFC), by scanning of a bar code, by causing the cryptographic wallet 460 to generate and display a quick response (QR) code, and/or the like) to transmit payment information from the cryptographic wallet 460 to the host device 480.

The cryptographic wallet 460 and the host device 480 can be physically separate and/or capable of being removably coupled. The ability to physically and communicatively uncouple the cryptographic wallet 460 from the host device 480 and other devices enables the air-gapped cryptographic wallet (e.g., cryptographic wallet 460) to act as “cold” storage, where the stored digital assets are moved offline and become inaccessible to the host device 480 and other devices. Further, the ability to physically and communicatively uncouple the cryptographic wallet 460 from the host device 480 allows the cryptographic wallet 460 to be implemented as a larger block of physical memory, which extends the storage capacity of the cryptographic wallet 460, similar to a safety deposit box or vault at a brick-and-mortar facility.

Accordingly, in some embodiments, the cryptographic wallet 460 and the host device 480 are physically separate entities. In such embodiments, the communications link 455 can include a computer network. For instance, the cryptographic wallet 460 and the host device 480 can be paired wirelessly via a short-range communications protocol (e.g., Bluetooth, ZigBee, infrared communication) or via another suitable network infrastructure. In some embodiments, the cryptographic wallet 460 and the host device 480 are removably coupled. For instance, the host device 480 can include a physical port, outlet, opening, or similar to receive and communicatively couple to the cryptographic wallet 460, directly or via a connector.

In some embodiments, the cryptographic wallet 460 includes tangible storage media, such as a dynamic random-access memory (DRAM) stick, a memory card, a secure digital (SD) card, a flash drive, a solid state drive (SSD), a magnetic hard disk drive (HDD), or an optical disc, and/or the like and can connect to the host device via a suitable interface, such as a memory card reader, a USB port, a micro-USB port, an eSATA port, and/or the like.

In some embodiments, the cryptographic wallet 460 can include an integrated circuit, such as a SIM card, a smart cart, and/or the like. For instance, in some embodiments, the cryptographic wallet 460 can be a physical smart card that includes an integrated circuit, such as a chip that can store data. In some embodiments, the cryptographic wallet 460 is a contactless physical smart card. Advantageously, such embodiments enable data from the card to be read by a host device as a series of application protocol data units (APDUs) according to a conventional data transfer protocol between payment cards and readers (e.g., ISO/IEC 7816), which enhances interoperability between the cryptographic payment ecosystem and payment card terminals.

In some embodiments, the cryptographic wallet 460 and the host device 480 are non-removably coupled. For instance, various components of the cryptographic wallet 460 can be co-located with components of the host device 480 in the housing of the host device 480. In such embodiments, the host device 480 can be a mobile device, such as a phone, a wearable, or similar, and the cryptographic wallet 460 can be built into the host device. The integration between the cryptographic wallet 460 and the host device 480 can enable improved user experience and extend the feature set of the cryptographic wallet 460 while preserving computing resources (e.g., by sharing the computing resources, such as transceiver, processor, and/or display or the host device 480). The integration further enables the ease of asset transfer between parties. The integration can further enhance loss protection options, as recovering a password or similar authentication information, rather than recovering a physical device, can be sufficient to restore access to digital assets stored in the cryptographic wallet 460. In some embodiments, the non-removably coupled cryptographic wallet can be air-gapped by, for example, disconnecting the host device 480 from the Internet.

As shown, the cryptographic wallet 460 can include a microcontroller 462. The microcontroller 462 can include or be communicatively coupled to (e.g., via a bus or similar communication pathway) at least a secure memory 464. The cryptographic wallet 460 can further include a transceiver 482a, and input/output circuit 484a, and/or a processor 486a. In some embodiments, however, some or all of these components can be omitted.

In some embodiments, the cryptographic wallet 460 can include a transceiver 482a and therefore can be capable of independently connecting to a network and exchanging electronic messages with other computing devices. In some embodiments, the cryptographic wallet 460 does not include a transceiver 482a. The cryptographic wallet 460 can be capable of connecting to or accessible from a network, via the transceiver 482b of the host device 480, when the cryptographic wallet 460 is docked to the host device 480. For example, in some embodiments, the user of the cryptographic wallet 460 can participate in token exchange activities on decentralized exchanges when the cryptographic wallet 460 is connected to the host device 480.

In some embodiments, the cryptographic wallet 460 can include an input/output circuit 484a, which may include user-interactive controls, such as buttons, sliders, gesture-responsive controls, and/or the like. The user-interactive controls can allow a user of the cryptographic wallet 460 to interact with the cryptographic wallet 460 (e.g., perform balance inquiries, convert tokens, access exchanges and/or marketplaces, perform transactions, access computing systems, and/or the like). In some embodiments, the user can access an expanded feature set, via the input/output circuit 484b of the host device 480, when the cryptographic wallet 460 is docked to the host device 480. For example, host device 480 can include computer-executable code structured to securely access data from the secure memory 464 of the cryptographic wallet 460 and to perform operations using the data. The data can include authentication information, configuration information, asset keys, and/or token management instructions. The data can be used by an application that executes on or by the host device 480. The data can be used to construct application programming interface (API) calls to other applications that require or use the data provided by cryptographic wallet 460. Other applications can include any on-chain or off-chain computer applications, such as dApps (e.g., decentralized lending applications, decentralized cryptocurrency exchanges, decentralized NFT marketplaces, decentralized gaming platforms, decentralized social media platforms, decentralized music streaming platforms), third-party computing systems (e.g., financial institution computing systems, social networking sites, gaming systems, online marketplaces), and/or the like.

The secure memory 464 is shown to include an authentication circuit 466 and a digital asset management circuit 472. The authentication circuit 466 and/or digital asset management circuit 472 include computer-executable code that, when executed by one or more processors, such as one or more processors of processor 486a and/or processor 486b, performs specialized computer-executable operations. For example, the authentication circuit 466 can be structured to cause the cryptographic wallet 460 to establish, maintain and manage a secure electronic connection with another computing device, such as the host device 480. The digital asset management circuit 472 can be structured to cause the cryptographic wallet 460 to allow a user to manage the digital assets accessible via the cryptographic wallet 460. In some embodiments, the authentication circuit 466 and the digital asset management circuit 472 are combined in whole or in part.

As shown, the authentication circuit 466 can include retrievably stored security, authentication, and/or authorization data, such as the authentication key 468. The authentication key 468 can be a numerical, alphabetic, or alphanumeric value or combination of values. The authentication key 468 can serve as a security token that enables access to one or more computing systems, such as the host device 480. For instance, in some embodiments, when the cryptographic wallet 460 is paired or docked to (e.g., establishes an electronic connection with) the host device 480, the user may be prompted to enter authentication information via the input/output circuit(s) of input/output circuit 484a and/or input/output circuit 484b. The authentication information may include a PIN, a password, a pass phrase, biometric information (e.g., fingerprint, a set of facial features, a retinal scan), a voice command, and/or the like. The authentication circuit 466 can compare the user-entered information to the authentication key 468 and maintain the electronic connection if the items match at least in part.

As shown, the authentication circuit 466 can include retrievably stored configuration information such as configuration information 470. The configuration information 470 can include a numerical, alphabetic, or alphanumeric value or combination of values. These items can be used to enable enhanced authentication protocols. For instance, the configuration information 470 can include a timeout value for an authorized connection between the cryptographic wallet 460 and the host device 480. The configuration information 470 can also include computer-executable code. In some embodiments, for example, where a particular cryptographic wallet, such as cryptographic wallet 460, is set up to pair with only one or a small number of pre-authorized host devices such as host device 480, the configuration information 470 can include a device identifier and/or other device authentication information, and the computer-executable code may be structured to verify the device identifier and/or other device authentication information against the information associated with or provided by the host device 480. When a pairing is attempted, the computer-executable code may initiate or cause the host device 480 to initiate an electronic communication (e.g., an email message, a text message, etc.) using user contact information stored as configuration information 470.

As shown, the digital asset management circuit 472 can include retrievably stored digital asset data, such as the asset key 474. The asset key 474 can be a numerical, alphabetic, or alphanumeric value or combination of values. In some embodiments, the asset key 474 is a private key in a public/private key pair, a portion thereof, or an item from which the private key can be derived. Accordingly, the asset key 474 proves ownership of a particular digital asset stored on a blockchain system 300. The asset key 474 can allow a user to perform blockchain transactions involving the digital asset. The blockchain transactions can include computer-based operations to earn, lend, borrow, long/short, earn interest, save, buy insurance, invest in securities, invest in stocks, invest in funds, send and receive monetary value, trade value on decentralized exchanges, invest and buy assets, sell assets, and/or the like. The cryptographic wallet 460 can be identified as a party to a blockchain transaction on the blockchain system 300 using a unique cryptographically generated address (e.g., the public key in the public/private key pair).

As shown, the digital asset management circuit 472 can also include retrievably stored asset management instructions such as asset management instructions 476. The asset management instructions 476 can include a numerical, alphabetic, or alphanumeric value or combination of values. These items can be used to enable computer-based operations related to managing digital assets identified by the asset key 474. For instance, the asset management instructions 476 can include parameter values, metadata, and/or similar values associated with various tokens identified by the asset key 474 and/or by the blockchain system 300 associated with particular tokens. The asset management instructions 476 can also include computer-executable code. In some embodiments, for example, asset management functionality (e.g., balance inquiry and the like) can be executable directly from the cryptographic wallet 460 rather than or in addition to being executable from the host device 480.

According to some embodiments herein, a blockchain system may be employed to facilitate transfer of data and/or transactions in an extended reality environment. For example, a cryptographic wallet may be used as a source of funds for the purchase of a product as a part of an online sales platform. In other embodiments, trust-based networks for transmission of data and completion of transactions may be employed, as the present disclosure is not so limited.

FIG. 5 is a block diagram illustrating an example machine learning (ML) system 500 that may be employed in some embodiments to generate three-dimensional assets for an extended-reality environment and/or floorplans. The ML system 500 is implemented using components of the example computer system 600 illustrated and described in more detail with reference to FIG. 6. For example, the ML system 500 can be implemented on the computer system 600 using instructions 608 programmed in the main memory 606 illustrated and described in more detail with reference to FIG. 4A. Likewise, embodiments of the ML system 500 can include different and/or additional components or be connected in different ways. The ML system 500 is sometimes referred to as a ML module.

The ML system 500 includes a feature extraction module 508 implemented using components of the example computer system 600 illustrated and described in more detail with reference to FIG. 4A. In some embodiments, the feature extraction module 508 extracts a feature vector 512 from input data 504. The feature vector 512 includes features 512a, 512b, . . . , 512n. The feature extraction module 508 reduces the redundancy in the input data 504, e.g., repetitive data values, to transform the input data 504 into the reduced set of features such as feature vector 512, e.g., features 512a, 512b, . . . , 512n. The feature vector 512 contains the relevant information from the input data 504, such that events or data value thresholds of interest can be identified by the ML model 516 by using this reduced representation. In some example embodiments, the following dimensionality reduction techniques are used by the feature extraction module 508: independent component analysis, Isomap, kernel principal component analysis (PCA), latent semantic analysis, partial least squares, PCA, multifactor dimensionality reduction, nonlinear dimensionality reduction, multilinear PCA, multilinear subspace learning, semidefinite embedding, autoencoder, and deep feature synthesis.

In some embodiments, the ML model 516 performs deep learning (also known as deep structured learning or hierarchical learning) directly on the input data 504 to learn data representations, as opposed to using task-specific algorithms. In deep learning, no explicit feature extraction is performed; the features of feature vector 512 are implicitly extracted by the ML system 500. For example, the ML model 516 can use a cascade of multiple layers of nonlinear processing units for implicit feature extraction and transformation. Each successive layer uses the output from the previous layer as input. The ML model 516 can thus learn in supervised (e.g., classification) and/or unsupervised (e.g., pattern analysis) modes. The ML model 516 can learn multiple levels of representations that correspond to different levels of abstraction, wherein the different levels form a hierarchy of concepts. In this manner, the ML model 516 can be con=figured to differentiate features of interest from background features.

In one example, the ML model 516, e.g., in the form of a CNN generates the output 524, without the need for feature extraction, directly from the input data 504. In some examples, the output 524 is provided to the computer device 528 or video display 618. The computer device 528 is a server, computer, tablet, smartphone, smart speaker, etc., implemented using components of the example computer system 600 illustrated and described in more detail with reference to FIG. 4A. In some embodiments, the steps performed by the ML system 500 are stored in memory on the computer device 528 for execution.

A CNN is a type of feed-forward artificial neural network in which the connectivity pattern between its neurons is inspired by the organization of a visual cortex. Individual cortical neurons respond to stimuli in a restricted area of space known as the receptive field. The receptive fields of different neurons partially overlap such that they tile the visual field. The response of an individual neuron to stimuli within its receptive field can be approximated mathematically by a convolution operation. CNNs are based on biological processes and are variations of multilayer perceptrons designed to use minimal amounts of preprocessing.

The ML model 516 can be a CNN that includes both convolutional layers and max pooling layers. The architecture of the ML model 516 can be “fully convolutional,” which means that variable sized sensor data vectors can be fed into it. For all convolutional layers, the ML model 516 can specify a kernel size, a stride of the convolution, and an amount of zero padding applied to the input of that layer. For the pooling layers, the ML model 516 can specify the kernel size and stride of the pooling.

In some embodiments, the ML system 500 trains the ML model 516, based on the training data 520, to correlate the feature vector 512 to expected outputs in the training data 520. As part of the training of the ML model 516, the ML system 500 forms a training set of features and training labels by identifying a positive training set of features that have been determined to have a desired property in question, and, in some embodiments, forms a negative training set of features that lack the property in question.

The ML system 500 applies ML techniques to train the ML model 516, that when applied to the feature vector 512, outputs indications of whether the feature vector 512 has an associated desired property or properties, such as a probability that the feature vector 512 has a particular Boolean property, or an estimated value of a scalar property. The ML system 500 can further apply dimensionality reduction (e.g., via linear discriminant analysis (LDA), PCA, or the like) to reduce the amount of data in the feature vector 512 to a smaller, more representative set of data.

The ML system 500 can use supervised ML to train the ML model 516, with feature vectors of the positive training set and the negative training set serving as the inputs. In some embodiments, different ML techniques, such as linear support vector machine (linear SVM), boosting for other algorithms (e.g., AdaBoost), logistic regression, naïve Bayes, memory-based learning, random forests, bagged trees, decision trees, boosted trees, boosted stumps, neural networks, CNNs, etc., are used. In some example embodiments, a validation set 532 is formed of additional features, other than those in the training data 520, which have already been determined to have or to lack the property in question. The ML system 500 applies the trained ML model (e.g., ML model 516) to the features of the validation set 532 to quantify the accuracy of the ML model 516. Common metrics applied in accuracy measurement include: Precision and Recall, where Precision refers to a number of results the ML model 516 correctly predicted out of the total it predicted, and Recall is a number of results the ML model 516 correctly predicted out of the total number of features that had the desired property in question. In some embodiments, the ML system 500 iteratively re-trains the ML model 516 until the occurrence of a stopping condition, such as the accuracy measurement indication that the ML model 516 is sufficiently accurate, or a number of training rounds having taken place. The validation set 532 can include data corresponding to confirmed environmental features, object motion, any other type of training set, or combinations thereof. This allows the detected values to be validated using the validation set 532. The validation set 532 can be generated based on analysis to be performed.

In some embodiments, ML system 500 is a generative artificial intelligence or generative AI system capable of generating text, images, or other media in response to prompts. Generative AI systems use generative models such as large language models to produce data based on the training data set that was used to create them. A generative AI system is constructed by applying unsupervised or self-supervised machine learning to a data set. The capabilities of a generative AI system depend on the modality or type of the data set used. For example, generative AI systems trained on words or word tokens are capable of natural language processing, machine translation, and natural language generation and can be used as foundation models for other tasks. In addition to natural language text, large language models can be trained on programming language text, allowing them to generate source code for new computer programs. Generative AI systems trained on sets of images with text captions are used for text-to-image generation and neural style transfer.

FIG. 6 is a block diagram illustrating an example computer system 600, in accordance with one or more embodiments. In some embodiments, components of the example computer system 600 are used to implement the blockchain system 300 or the ML system 500 illustrated and described in more detail with reference to FIGS. 3 and 5. At least some operations described herein can be implemented on the computer system 600.

The computer system 600 can include one or more central processing units (“processors”) such as one or more processors 602, and can further include main memory 606, non-volatile memory 610, network adapter 612 (e.g., network interface), video displays 618, input/output devices 620, control devices 622 (e.g., keyboard and pointing devices), drive units 624 including a storage medium 626, and a signal generation device 630 that are communicatively connected to a bus 616. The bus 616 is illustrated as an abstraction that represents one or more physical buses and/or point-to-point connections that are connected by appropriate bridges, adapters, or controllers. The bus 616, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The computer system 600 can share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the computer system 600.

While the main memory 606, non-volatile memory 610, and storage medium 626 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 628. The term “machine-readable medium” and “storage medium” shall also be taken to include any medium that is capable of storing, encoding, or carrying a set of instructions for execution by the computer system 600.

In general, the routines executed to implement the embodiments of the disclosure can be implemented as part of an operating system or a specific application, component, program, object, module, or sequence of instructions (collectively referred to as “computer programs”). The computer programs typically include one or more instructions (e.g., instructions 604, 608, 628) set at various times in various memory and storage devices in a computer device. When read and executed by the one or more processors 602, the instruction(s) cause the computer system 600 to perform operations to execute elements involving the various aspects of the disclosure.

Moreover, while embodiments have been described in the context of fully functioning computer devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and/or non-volatile memory 610, floppy and other removable disks, hard disk drives, optical discs (e.g., Compact Disc Read-Only Memory (CD-ROMS), Digital Versatile Discs (DVDs)), and transmission-type media such as digital and analog communication links.

The network adapter 612 enables the computer system 600 to mediate data in a network 614 with an entity that is external to the computer system 600 through any communication protocol supported by the computer system 600 and the external entity. The network adapter 612 can include a network adapter card, a wireless network interface card, a router, an access point, a wireless router, a switch, a multilayer switch, a protocol converter, a gateway, a bridge, a bridge router, a hub, a digital media receiver, and/or a repeater.

The network adapter 612 can include a firewall that governs and/or manages permission to access proxy data in a computer network and tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall can additionally manage and/or have access to an access control list that details permissions including the access and operation rights of an object by an individual, a machine, and/or an application, and the circumstances under which the permission rights stand.

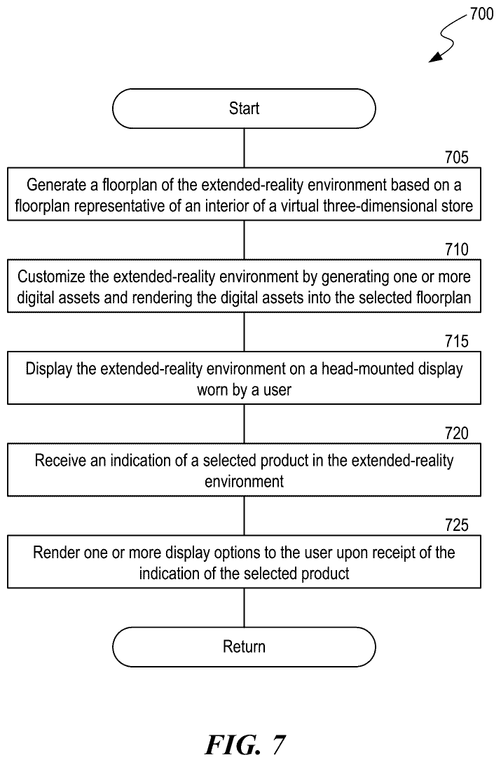

FIG. 7 is a flow diagram illustrating a process 700 for generating and displaying an extended-reality environment, in accordance with one or more embodiments of this disclosure. In some implementations, process 700 is performed by system 100 or HMD 200 described in more detail with reference to FIGS. 1-2. In some implementations, the process is performed by a computer system, e.g., the example computer system 600 illustrated and described in more detail with reference to FIG. 6. Particular entities, for example, an XR device or an ML system perform some or all of the steps of process 700 in other implementations. Likewise, implementations can include different and/or additional steps or can perform the steps in different orders. In some embodiments, the method of FIG. 7 may be performed by a processor configured to execute computer-readable instructions stored in the non-transitory computer memory, wherein when the computer-readable instructions are executed the processor is configured to perform the method of FIG. 7.

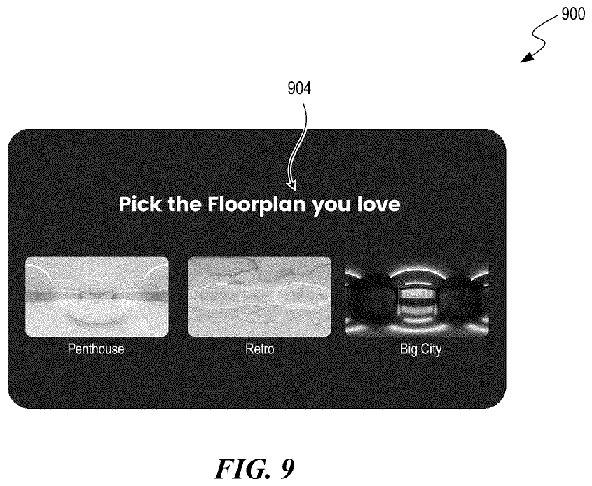

In act 705, a computer system is configured to generate a floorplan of the extended-reality environment based on a floorplan representative of an interior of a virtual three-dimensional store. The floorplan may be selected according to user input from a plurality of pre-defined floorplans. The plurality of floorplans may correspond to different, sizes, layouts, themes or environments. In some embodiments, a floorplan may be selected on a graphical user interface. In some embodiments, a pre-design floorplan may be a three-dimensional digital model of a store. An example of a graphical user interface for selecting a pre-defined floorplan is shown in FIG. 9.

In act 710, the computer system is configured to customize the extended-reality environment by generating one or more digital assets and rendering the digital assets into the selected floorplan from act 705. The computer system may be configured to customize the extend-reality environment based on input received from a user. In some embodiments, the user input may be received at a graphical user interface. In some embodiments, the one or more digital assets may be selected by the user from a plurality of digital assets via the graphical user interface. In some embodiments, the one or more digital assets may be selected by a drag and drop selection mechanism of the graphical user interface. In some cases, the one or more digital assets may be pre-defined assets stored in memory. In such cases, “generating” one or more digital assets may include rendering the pre-defined asset in the extended-reality environment. In other cases, “generating” one or more digital assets may include providing input to a generative machine learning model or another machine learning algorithm that, in response to the input, is configured to output one or more digital assets that may be rendered into the extended-reality environment. The generative machine learning model may be trained on training input data, and in some cases, may be configured to generate three-dimensional digital assets from input of two-dimensional images. In some embodiments, the one or more digital assets may include a virtual interactive activity, such as a game, sports simulation, puzzle, etc. The virtual activity may be responsive to user input (e.g., via one or more controllers) and therefore interactive. In some embodiments, the one or more digital assets may include a virtual customizable asset to be displayed in the floorplan of the extended-reality environment. The virtual customizable asset may be generated by a generative machine learning model in some embodiments, as discussed above. In some embodiments, the one or more digital assets may include a two-dimensional picture of a product, two-dimensional wall art image, and/or a soundtrack (e.g., background music, ambient sound, etc.). In the case of two-dimensional images, images may be rendered on virtual walls of the extended-reality environment. In the case of a soundtrack, audio may be rendered through speaker or headphones to a user while the user is viewing the extended-reality environment.

In act 715, the computer system is configured to display the extended-reality environment on a head-mounted display worn by a user. The extended-reality environment is based on the selected floorplan from act 705. The extended-reality environment may include a virtual simulation of a physical environment, such as a room or store. The extended-reality environment may instead be an augmented reality display of a physical environment. In such an arrangement, a head-mounted display may include a camera to capture images of a physical environment which are rendered on the head-mounted display with overlaid digital assets. Alternatively, a head-mounted display may include a transparent display through which a user can view the physical environment while the transparent display also renders digital assets. In some embodiments, the extended-reality environment may include an avatar corresponding to the user that may be controlled by the user. In some embodiments, the avatar may be displayed from a first-person perspective.

In act 720, the computer system is configured to receive an indication of a selected product in the extended-reality environment. In some embodiments, the product may be rendered in the extended-reality environment as a three-dimensional model or as a two-dimensional image. The product may be represented by a digital asset added to the extended-reality environment in act 710. In some embodiments, the indication of a selected product may be received as user input. In some embodiments, the user input may be received via one or more controllers, for example, handheld controllers. In other embodiments, the user input may be received via one or more sensors of a head-mounted display. For example, a head-mounted display may include an eye tracking sensor configured to track the eyes of a user, and a product selection may be indicated by looking at an object for a non-zero period of time or by another ocular movement. As another example, a head-mounted display may include an accelerometer configured to detect motion of a user's head, and a gesture based on a motion of the user's head (e.g., a nod) may be received as an input indicating a selection of a product. In some embodiments, a combination of inputs may be received which indicate a selection of the product in the extended-reality environment.

In act 725, the computer system is configured to render one or more display options to the user upon receipt of the indication of the selected product. In some embodiments, rendering the one or more display options includes displaying the display options within the extended-reality environment viewed through the head-mounted display.

In some embodiments, the one or more display options include a manipulable three-dimensional model of the selected product. In some embodiments, the manipulable three-dimensional model may be a three-dimensional model already rendered in the extended-reality environment. In such cases, upon receipt of the selection, the three-dimensional model may be optionally enlarged, optionally move, or otherwise become responsive to user input. Such an arrangement may simulate taking a product “off-the-shelf” to handle the product. In other embodiments, the product may be represented as a two-dimensional image in the extended-reality environment. In such cases, selection of the product may cause the product to morph from a two-dimensional image to a three-dimensional model. In some embodiments, being “manipulable” may mean the three-dimensional model is freely rotatable about three axes, for example, roll, pitch, and yaw. In some embodiments, being “manipulable” may mean the three-dimensional model is configured to have one or more animations that may be trigged based on input from the user. In some embodiments, being “manipulable” may mean the three-dimensional model includes one or more movable components, which may be translated and/or rotated relative to other components of the three-dimensional model.

In some embodiments, the one or more display options may include information related to the selected product. The information related to the selected product may be text, which may include, but is not limited to, a name of the selected product, a price of the selected product, a description of the selected product, materials of the selected product, colors of the selected product, shipping information, country of manufacture of the selected product, and the like. In some cases, the text may be rendered within the extended-reality environment in a text pane.

In some embodiments, the one or more display options may include displaying the product being used by the avatar in the extended-reality environment to enable visualization of the selected product. In some embodiments, the product may be displayed in hands of the avatar. In other embodiments, if the product is clothing the product may be displayed as being worn by the avatar. In some embodiments, the avatar in an extended-reality environment may share one or more visual characteristics with an avatar associated with the user on another platform. For example, a user may have a previously configured avatar with specific characteristics (e.g., height, weight hair style, hair color, face style, clothing, and the like) in the other platform. Such an avatar may be imported into the extended-reality environment. In some embodiments, the avatar may be associated with an application hub, which in turn may be associated with specific head-mounted display hardware.

In some embodiments, the one or more display options may include displaying the product in the virtual simulation of a physical environment to enable visualization of the selected product. In some embodiments, the physical environment may be different than that of the extended-reality environment in which the product was displayed initially. The physical environment may be an environment in which the product is intended to be used. For example, a sports product may be displayed in a sports court or sports field environment according to the specific sport of the product. As another example, a kitchen appliance may be displayed in a kitchen environment. As yet another example, a sofa may be displayed in a living room environment. In this manner, a user may view the product in a different virtual physical environment than the extended-reality environment representative of a storefront.

In some embodiments, the one or more display options may include displaying a payment platform wherein the user is able to purchase the selected product without leaving the extended-reality environment. In some embodiments, the payment platform may be rendered as a pane in the extended-reality environment. In some embodiments, a virtual point-of-sale may be rendered to allow a user to process payment based on user input. In some embodiments, a payment platform may be connected to an online sales platform. The online sales platform may be configured to record a quantity of product available for purchase and provide that information to the payment platform. The online sales platform may further update the quantity upon receipt of a sale from the payment platform.

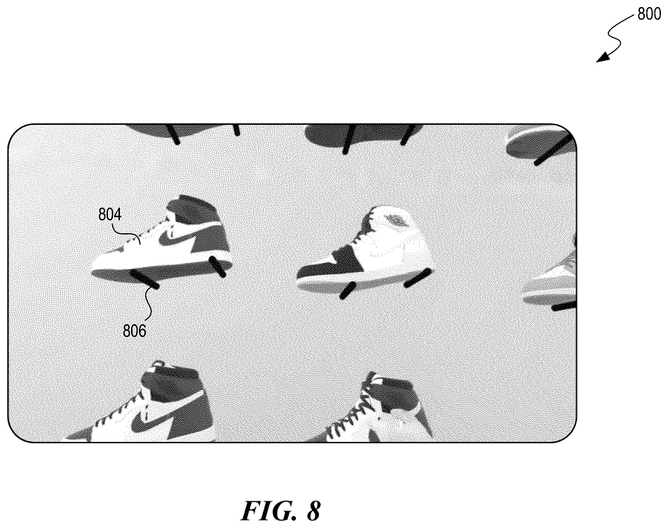

FIG. 8 depicts an example of an extended-reality storefront 800 as an extended-reality environment. As shown in FIG. 8, a plurality of products 804 are shown in the extended-reality storefront. The plurality of products 804 in the example of FIG. 8 are shoes. The products 804 are depicted as three-dimensional models within the extended-reality storefront. In the example of FIG. 8, the three-dimensional models are rendered on shelving 806 of the extended-reality environment. In some embodiments, a user may be able to drag and drop product models to open spaces corresponding to spaces on the shelving in a graphical user interface. In some embodiments, a user may be able to select one of the products while viewing the extended-reality environment. Upon receiving an indication of a selection, a computer system may enlarge the selected product. In some embodiments, the selection of the product may allow the product to be manipulated by the user in response to user input. In some embodiments, the selection of the product may display the product on an avatar of the user, for example, feet of the avatar. According to some embodiments, the three-dimensional product models shown in FIG. 8 may be generated by a generative machine learning model or a machine learning algorithm based on input of two-dimensional product images, in some embodiments.

FIG. 9 depicts an example of an interface 900 during a process of building an extended-reality storefront. As shown in FIG. 9, the interface 900 may be a graphical user interface displayed on a screen, for example, of a computer or mobile device. The interface 900 may prompt 904 a user, in some embodiments. In the example of FIG. 9, the interface 900 may present a plurality of pre-defined floorplans for an extended-reality environment. A user may select between the plurality of pre-defined floorplan to generate an extended-reality environment based on the selected pre-defined floorplan. Each floorplan may be representative of a three-dimensional model and textures stored in non-transitory memory of a computer system. In some embodiments as shown in FIG. 9, the pre-defined floorplans may correspond to themes. In FIG. 9, three pre-defined floorplans are depicted, corresponding to the themes “Penthouse”, “Retro”, and “Big City”. The floorplans may have different sizes, architectural features, textures, and digital assets depicted in connection with their display in an extended-reality environment. By allowing a user to select between pre-defined floorplans, a user may generate an extended-reality environment as a storefront without the use of code. In some embodiments, upon receiving a selection of a pre-defined floorplan, the selection may be saved to non-transitory computer memory. In some embodiments, when an extended-reality environment is generated and rendered on a head-mounted display, a computer system may retrieve the pre-defined floorplan from memory according to the saved selection.

In some embodiment, a floorplan may be generated by one or more generative machine learning models. In such embodiments, pre-defined floorplans may not be selected by a user, but a user may include provide design instructions via a graphical user interface (GUI). Based on the instructions as input, one or more generative machine learning models may output at least one floorplan. A computer system may then display, via the GUI, a particular floorplan generated by one or more generative machine learning models. The displayed floorplans are generated by the one or more generative machine learning models in response to the particular floorplan design instructions, and are not pre-defined according to this embodiment, but may be displayed similar to the interface shown in FIG. 9. The one or more generative machine learning models may be trained to generate, in response to input training data, a corresponding floorplan, and the corresponding floorplan comprises a newly generated portion of content that shares one or more properties with the input training data and thereby extends the input training data.

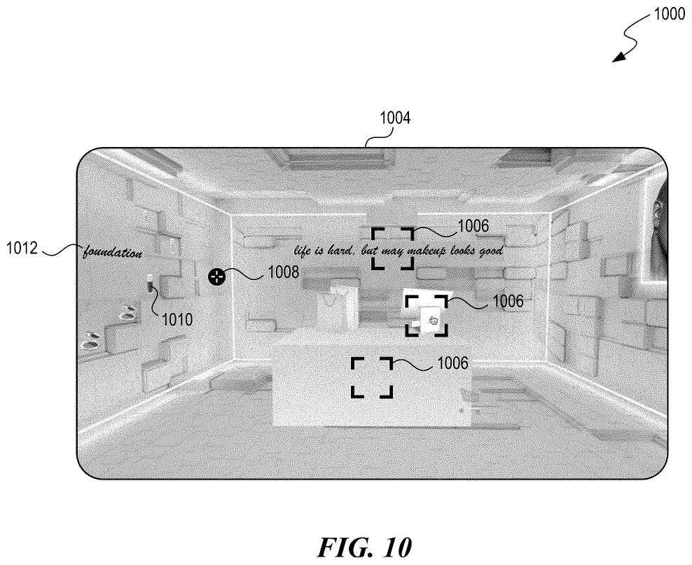

FIG. 10 depicts an example of an interface 1000 during a process of building an extended-reality storefront 1004 as an extended-reality environment. Depicted in FIG. 10 is an extended-reality environment as viewed through the interface 1000 which may be rendered on a display, for example, a computer display or head-mounted display. In some embodiments, a computer system may allow a user to customize an extended-reality storefront 1004 via a drag and drop mechanism. In some embodiments, a predefined floorplan that may be rendered as the extended-reality environment may include a plurality of asset openings 1006 that may be configured to receive pre-defined or imported assets from a user. Each of the asset openings 1006 may have an opening type assigned that is configured to display a corresponding type of asset. For example, an asset opening on a wall of the extended-reality environment may be configured display a two-dimensional asset (e.g., a two-dimensional image). As another example, an asset opening on a shelf of the extended-reality environment may be configured to display a three-dimensional asset (e.g., a three-dimensional model of a product, three-dimensional artwork, etc.). In some embodiments, a cursor 1008 may be used to select an asset opening 1006 on the interface 1000. Once selected, the user may be presented with a list of available assets that might be displayed in the selected asset opening. A user may then select an asset from the list of available assets and the asset may be rendered in the selected asset opening 1006. In some other embodiments, the cursor 1008 may be used to select an asset from a list of available assets. Once selected, the cursor 1008 may be used to drag the selected asset from the list to one of the asset openings 1006. In some embodiments, only asset openings 1006 of a type corresponding to a type of the selected asset may appear on the interface 1000 for a user to drop the selected asset into. Accordingly, asset openings 1006 displayed on the interface 1000 may allow a user to customize an extended-reality environment. As shown in FIG. 10, a three-dimensional asset 1010, such as a product, may be displayed in an asset opening 1006. Additionally, a two-dimensional asset 1012, such as an image, may be displayed in an asset opening 1006. In some embodiments, an asset may be displayed and assigned to multiple asset openings 1006.

According to some embodiments, a list of assets that may be added to an extended-reality environment via asset openings 1006 may be pre-existing assets. For example, pre-existing assets may be stored in non-transitory memory of a computer system. In some embodiments, the list of assets may be based on a selected pre-defined floorplan. In some embodiments, an interface 1000 may allow a user to customize assets by adjusting one or more parameters of an asset. For example, a user may select and asset and customize one or more parameters (e.g., with the cursor 1008) or by another mechanism. The parameters may include, but are not limited to, colors, text, and size. For example, the content of text of an asset may be adjusted based on text input by a user. In this manner customized signage or other assets may be introduced into an extended-reality environment without actually importing customized assets. In some embodiments, a user may import custom assets to be included in the list of assets for assignment to one or more asset openings 1006. In some embodiments, “importing” an asset may include uploading the asset to non-transitory memory of a computer system. For example, two-dimensional image files and three-dimensional model files may be uploaded into non-transitory memory of the computer system, where they may be included in the list of assets available for placement in the asset openings 1006. In some embodiments, “importing” an asset may include specifying one or more parameters of the imported asset, for example, a type of the asset. In some embodiments, “importing” an asset may include inputting a file into a generative machine learning model or a machine learning algorithm to obtain an output based on the input. The generative machine learning model and machine learning algorithms may be trained on input training data, such that the output based on a new input extends the training data. In some embodiments, a generative machine learning model or a machine learning algorithm may be employed to change a type of asset. For example, a two-dimensional image may be input to a generative machine learning model or machine learning algorithm that outputs a three-dimensional model. The output of the generative machine learning model or machine learning algorithm may be included in the list of assets for placement in the asset openings 1006. In some embodiments, a machine learning module may extract, from a particular two-dimensional image of a product, a feature vector describing the particular two-dimensional image of a product. The machine learning algorithm may further generate, using a machine learning model, a particular three-dimensional model of a product based on the extracted feature vector. The machine learning model may be trained, based on input training features, to produce a corresponding three-dimensional model of a product from feature vectors extracted from a two-dimensional image.

In some embodiments, after assets have been assigned to asset openings 1006, the configuration of the extended-reality environment may be saved in non-transitory memory. When viewed by another user, a computer system may retrieve the saved configuration to render the extended-reality environment as configured by the user as shown in FIG. 10. In some embodiments, customized asset configurations and imported assets may be saved into non-transitory memory. In some embodiments, a configuration file and imported assets may be transmitted for storage on a remote server. In this manner, a user may customize an extended-reality environment with no code, and an extended-reality environment may be rendered to another user based on a saved configuration.

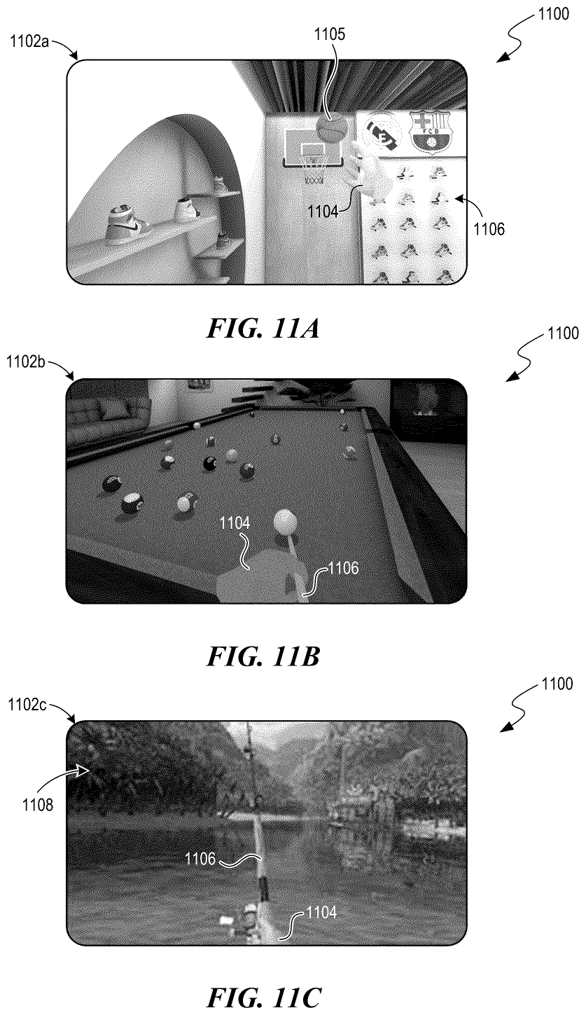

FIGS. 11A-11C depict examples of an extended-reality storefront 1100 and a plurality of virtual activities that may be included as a part of an extended-reality environment generated according to methods described herein. In some embodiments, virtual activities may be added to an extended-reality environment in a manner similar to that described in FIG. 10. For example, virtual activities may be includes in a list of assets that may be placed in certain asset openings in a digital floorplan. In some embodiments, digital floorplans may have asset openings of a type corresponding to virtual activities.

A first virtual activity 1102a shown in FIG. 11A is a sports simulation. Specifically, FIG. 11A depicts a hand 1104 of an avatar of the user, which may be responsive to user input (e.g., via one or more controllers). A virtual ball 1105 is rendered in the extended-reality storefront 1100, which may be manipulated by the hand 1104. The ball may be shot at a basketball net forming a part of the extended-reality storefront 1100. As shown in FIG. 11A, the first virtual activity 1102a is integrated in the same environment that depicts a plurality of products 1106 that may be displayed based on a user configuration, for example, as discussed with reference to FIG. 10.

FIG. 11B depicts a second virtual activity 1102b which is a game, for example, pool. Specifically, FIG. 11B depicts a hand 1104 of an avatar of the user, which may be responsive to user input (e.g., via one or more controllers). In the example of FIG. 11B, a product 1106 may be a pool cue, which is incorporated into the virtual activity. In some embodiments, a user may select a product 1106, which in this case is a pool cue. Upon receipt of the selection, a computer system may render the virtual activity 1102b so that a user can try the selected product in an interactive activity in which the product is used. Similar to FIG. 11A, the activity of FIG. 11B is rendered inside of the existing extended-reality storefront 1100.

FIG. 11C depicts a third virtual activity 1102c which is a spot activity in different environment 1108. Specifically, FIG. 11C depicts the interactive activity of fishing in a lake environment 1108 that is different from the extended-reality storefront 1100 shown in FIGS. 11A and 11B. In the activity of FIG. 11C, a hand 1104 of an avatar of a user is controllable to interact with one or more objects in the environment. As shown in FIG. 11C, a product 1106 is a fishing rod which is manipulated by the hand 1104. In some embodiments, a computer system may be configured to switch the environment from a storefront to another physical environment on receipt of a selection of a product. For example, as shown in FIG. 11C, the selected product 1106 as a fishing rod may be shown in a lake environment 1108 once selected. A user may be able to physically manipulate the product 1106 in the new physical environment. Additionally, the selected product may be used in a virtual activity. In the depicted example, a fishing minigame may be played with the selected fishing rod by manipulating the fishing rod with the hand 1104.

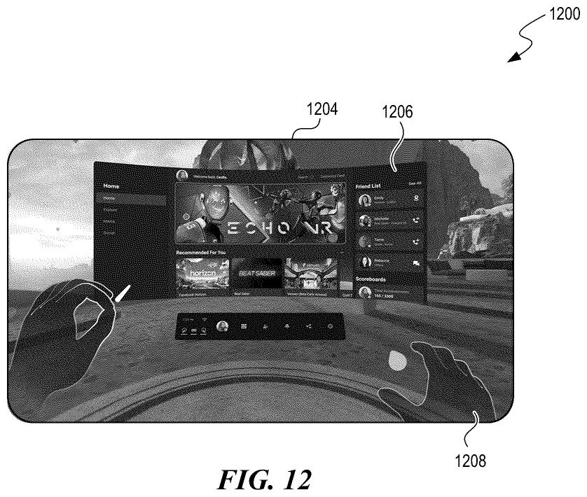

FIG. 12 depicts an example of an interface 1200 for deploying an extended-reality storefront to an extended-reality application hub. In the example of FIG. 12, an extended-reality environment 1204 is rendered on a head-mounted display. The extended-reality environment shown in FIG. 12 may not be an extended-reality storefront. A menu pane 1206 is shown in the extended-reality environment 1204. The menu pane 1206 provides an example of a pane in which text information or other information may be displayed to a user while the user is viewing an extended-reality environment. For example, upon selection of a product in an extended-reality storefront, a pane similar to that shown in FIG. 12 may be generated that includes information regarding the product or a payment platform. In some embodiments, rendering display options in an extended-reality environment may not obscure other previously rendered display options. In some embodiments, a payment platform may be accomplished through a transaction with a cryptographic wallet as described herein. As shown in FIG. 12, an avatar 1208 of the user may be displayed in the extended-reality environment, which may give a user context for selection of options. The menu pane 1206 may be representative of a menu for deploying an extended-reality environment generated according to methods described herein to an application hub. Through an application hub, end users may download a downloadable app from the application hub and enter the extended-reality environment via their own head-mounted displays. In some embodiments, a user may upload a configuration file and any imported assets to a remote server to make the configuration and imported assets available to other end users.

Execution of methods described herein (e.g., the method of FIG. 7) causes a reduction in greenhouse gas emissions compared to traditional retail experiences. Traditional retail environments are large producers of greenhouse gases in both the use of resources to construct the retail space, transportation of goods and employees, and air conditioning. The retail sector accounts for roughly 25% of global carbon emissions. According to a 2020 MIT Lab study Retail Carbon Footprints: Measuring Impacts from Real Estate and Technology, approximately 0.749 kgCO2e/item is generated for e-commerce, versus 1.181 kgCO2e/item for in-store retail in a base case. However, for reasons discussed herein, traditional retail is still attractive to many consumers and retail businesses. Methods described herein will increase the adoption of ecommerce and extended-reality shopping to displace traditional retail shopping, thereby reducing carbon emissions. Additionally, a significant portion of ecommerce returns are due to the customer not understanding the product well enough to know if they need or want it. Accordingly, returns and associated transportation and packaging costs account for a large portion of ecommerce carbon emissions. By providing an extended-reality environment in which products are able to be manipulated and used in interactive activities more akin to a traditional retail environment, a customer can better understand the product and therefore is less likely to return an item. Therefore, the disclosed implementations mitigate climate change and the effects of climate change by displacing traditional retail and also reducing returns in ecommerce.

The functions performed in the processes and methods can be implemented in differing order. Furthermore, the outlined steps and operations are only provided as examples, and some of the steps and operations can be optional, combined into fewer steps and operations, or expanded into additional steps and operations without detracting from the essence of the disclosed embodiments.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

The description and drawings herein are illustrative and are not to be construed as limiting. Numerous specific details are described to provide a thorough understanding of the disclosure. However, in certain instances, well-known details are not described in order to avoid obscuring the description. Further, various modifications can be made without deviating from the scope of the embodiments.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms can be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms can on occasion be used interchangeably.

Consequently, alternative language and synonyms can be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any term discussed herein, is illustrative only and is not intended to further limit the scope and meaning of the disclosure or of any exemplified term. Likewise, the disclosure is not limited to various embodiments given in this specification.

It is to be understood that the embodiments and variations shown and described herein are merely illustrative of the principles of this invention and that various modifications can be implemented by those skilled in the art.

What is claimed is:

1. A computer-implemented method for generating a no-code, three-dimensional extended-reality environment, the method comprising:
generating a floorplan of the extended-reality environment based on a floorplan representative of an interior of a virtual three-dimensional store,
wherein the extended-reality environment is configured to be displayed on a head-mounted display configured to be worn by a user, and
wherein the extended-reality environment includes at least one selected from the group of:
a virtual simulation of a physical environment, or
an augmented reality display of a physical environment;
customizing the extended-reality environment by generating a virtual customizable asset to be displayed in the floorplan of the extended-reality environment, wherein the virtual customizable asset is added to the floorplan of the extended-reality environment using a drag and drop selection mechanism; and
upon receiving an indication of a selected product from a user, presenting a plurality of display options associated with the selected product,
wherein the plurality of display options includes at least one selected from the group of:
displaying a manipulable three-dimensional model of the selected product,
displaying additional information related to the selected product,
displaying the product being used by an avatar in the virtual three-dimensional store to enable visualization of the selected product,
displaying the product in the virtual simulation of a physical environment to enable visualization of the selected product, and
displaying a payment platform wherein the user is able to purchase the selected product without leaving the extended-reality environment.

2. The method of claim 1, wherein the virtual customizable asset is at least one selected from the group of:
a three-dimensional model of a product created by a machine learning algorithm, the machine learning algorithm including:
extracting, from a particular two-dimensional image of a product, a feature vector describing the particular two-dimensional image of a product; and
generating, using a machine learning algorithm, a particular three-dimensional model of a product based on the feature vector,
wherein the machine learning algorithm is trained, based on input training features, to produce a corresponding three-dimensional model of a product,
a picture of a product,
wall art,
video content, and
background music.

3. The method of claim 1, wherein the floorplan is generated by:
obtaining particular floorplan design instructions via a graphical user interface (GUI); and
displaying, via the GUI, a particular floorplan generated by one or more generative machine learning algorithms,
wherein the particular floorplan is generated by the one or more generative machine learning algorithms in response to the particular floorplan design instructions,
wherein the one or more generative machine learning algorithms are trained to generate, in response to input training data, a corresponding floorplan, and
wherein the corresponding floorplan comprises a newly generated portion of content that shares one or more properties with the input training data and thereby extends the input training data.

4. The method of claim 1, wherein the three-dimensional model of a product is generated by:
obtaining a particular two-dimensional image of a product via a GUI; and
displaying, via the GUI, a particular three-dimensional model of a product generated by one or more generative machine learning algorithms,
wherein the particular three-dimensional model of a product is generated by the one or more generative machine learning algorithms in response to the particular two-dimensional image of a product,
wherein the one or more generative machine learning algorithms are trained to generate, in response to input training data, a corresponding three-dimensional model of a product, and
wherein the corresponding three-dimensional model of a product comprises a newly generated portion of content that shares one or more properties with the input training data and thereby extends the input training data.

5. The method of claim 1, further comprising generating an avatar configured to be displayed within the extended-reality environment and that is controllable by the user, wherein the avatar shares visual characteristics with an avatar associated with the user on another platform.

6. The method of claim 1, wherein the indication of a selected product is made by an ocular movement detected by the head-mounted display.

7. The method of claim 1, wherein the head-mounted display is located in a physical store and the extended-reality environment is customized to augment a shopping experience in the physical store.

8. The method of claim 1, further comprising:
recording a quantity of the product available for purchase; and
updating the quantity when a purchase is made on the payment platform.

9. The method of claim 1, further comprising:
upon receiving the indication of a selection of a display option, rendering a display based on the display option without obscuring any other displays that were previously rendered.

10. The method of claim 1, further comprising customizing the extended-reality environment by generating a virtual interactive activity that is an activity associated with a product in the extended-reality environment.

11. The method of claim 1, wherein generating a floorplan of the extended-reality environment based on a floorplan configured to display an interior of a virtual three-dimensional store causes a reduction in greenhouse gas emissions compared to providing a physical environment based on the floorplan.

12. A system for generating an extended-reality environment, the system comprising:
head-mounted display configured to be worn by a user;
a non-transitory computer memory;
a processor configured to execute computer-readable instructions stored in the non-transitory computer memory, wherein when the computer-readable instructions are executed the processor is configured to:
generate a floorplan of the extended-reality environment based on a floorplan representative of an interior of a virtual three-dimensional store,
wherein the extended-reality environment includes at least one selected from the group of:
a virtual simulation of a physical environment, and
an augmented reality display of a physical environment;
display the extended-reality environment on the head-mounted display to the user;
customize the extended-reality environment by generating and displaying on the head-mounted display a virtual customizable asset to be displayed in the floorplan of the extended-reality environment, wherein the virtual customizable asset is added to the floorplan of the extended-reality environment using a drag and drop selection mechanism; and
upon receiving an indication of a selected product from a user, present a plurality of display options associated with the selected product on the head-mounted display,
wherein the plurality of display options includes at least one selected from the group of:
displaying a manipulable three-dimensional model of the selected product,
displaying additional information related to the selected product,
displaying the product being used by an avatar in the virtual three-dimensional store to enable visualization of the selected product,
displaying the product in the virtual simulation of a physical environment to enable visualization of the selected product, and
displaying a payment platform wherein the user is able to purchase the selected product without leaving the extended-reality environment.

13. The system of claim 12, wherein the floorplan is generated by:
obtaining particular floorplan design instructions via a graphical user interface (GUI); and
displaying, via the GUI, a particular floorplan generated by one or more generative machine learning algorithms,
wherein the particular floorplan is generated by the one or more generative machine learning algorithms in response to the particular floorplan design instructions,
wherein the one or more generative machine learning algorithms are trained to generate, in response to input training data, a corresponding floorplan, and
wherein the corresponding floorplan comprises a newly generated portion of content that shares one or more properties with the input training data and thereby extends the input training data.

14. The system of claim 12, wherein the three-dimensional model of a product is generated by:
obtaining a particular two-dimensional image of a product via a GUI; and
displaying, via the GUI, a particular three-dimensional model of a product generated by one or more generative machine learning algorithms,
wherein the particular three-dimensional model of a product is generated by the one or more generative machine learning algorithms in response to the particular two-dimensional image of a product,
wherein the one or more generative machine learning algorithms are trained to generate, in response to input training data, a corresponding three-dimensional model of a product, and
wherein the corresponding three-dimensional model of a product comprises a newly generated portion of content that shares one or more properties with the input training data and thereby extends the input training data.

15. The system of claim 12, wherein when the computer-readable instructions are executed the processor is further configured to generate and display an avatar configured within the extended-reality environment that is controllable by the user, wherein the avatar shares visual characteristics with an avatar associated with the user on another platform.

16. The system of claim 12, wherein the indication of a selected product is made by an ocular movement detected by the head-mounted display.

17. The system of claim 12, wherein the payment platform is connected to an online sales platform, the online sales platform is configured to:
transmit, to the processor, a quantity of the product available for purchase;
receive, from the processor, a purchase request from the user, and
update the quantity upon receive of the purchase request.

18. The system of claim 12, wherein the virtual customizable asset is at least one selected from the group of:
a three-dimensional model of a product created by a machine learning algorithm, the machine learning algorithm including:
extracting, from a particular two-dimensional image of a product, a feature vector describing the particular two-dimensional image of a product; and
generating, using a machine learning algorithm, a particular three-dimensional model of a product based on the feature vector,
wherein the machine learning algorithm is trained, based on input training features, to produce a corresponding three-dimensional model of a product,
a picture of a product,
wall art,
video content, and
background music.

19. The system of claim 12, wherein generating a floorplan of the extended-reality environment based on a floorplan configured to display an interior of a virtual three-dimensional store causes a reduction in greenhouse gas emissions compared to providing a physical environment based on the floorplan.

20. A non-transitory computer readable medium with instructions stored thereon that, when executed by a processor of a computing device, cause the computing device to perform operations comprising:
generating a floorplan of the extended-reality environment based on a floorplan representative of an interior of a virtual three-dimensional store,
wherein the extended-reality environment is configured to be displayed on a head-mounted display configured to be worn by a user, and
wherein the extended-reality environment includes at least one selected from the group of:
a virtual simulation of a physical environment, or
an augmented reality display of a physical environment;
customizing the extended-reality environment by generating a virtual customizable asset to be displayed in the floorplan of the extended-reality environment, wherein the virtual customizable asset is added to the floorplan of the extended-reality environment using a drag and drop selection mechanism; and
upon receiving an indication of a selected product from a user, presenting a plurality of display options associated with the selected product,
wherein the plurality of display options includes at least one selected from the group of:
displaying a manipulable three-dimensional model of the selected product,
displaying additional information related to the selected product,
displaying the product being used by an avatar in the virtual three-dimensional store to enable visualization of the selected product,
displaying the product in the virtual simulation of a physical environment to enable visualization of the selected product, and
displaying a payment platform wherein the user is able to purchase the selected product without leaving the extended-reality environment.
